(19) United States
(12) Patent Application Publication
(10) Pub. No.: US 2026/0330842 A1
(43) Pub. Date: Oct. 22, 2026

(54) ARTIFICIAL NEURAL NETWORK SYSTEM FOR RECOGNIZING 3D OBJECT BASED ON ACCUMULATED SEQUENCE DATA AND METHOD FOR IMPLEMENTING THE SAME

(71) Applicants: Hyundai Motor Company, Seoul (KR); Kia Corporation, Seoul (KR)

(72) Inventor: Jun Hyung LEE, Hwaseong-Si (KR)

(21) Appl. No.: 19/414,576

(22) Filed: Dec. 10, 2025

(30) Foreign Application Priority Data
Apr. 17, 2025 (KR) 10-2025-0050387

(51) Int. Cl. G06V 20/58; B60W 60/00

(52) U.S. Cl. CPC G06V 20/58; B60W 60/0011

(57) ABSTRACT

Disclosed is an apparatus for executing a local spatiotemporal feature information computation and augmentation operation and recognizing an object. The apparatus may specify, based on a predetermined local space configuration scheme, a local space index for performing an augmentation operation associated with an object; register, based on the local space index, initialized point spatiotemporal registration information; search for a point corresponding to the specified local space index; specify a frame index for performing the augmentation operation; determine a point index by searching for a point corresponding to the specified frame index; define, at the specified frame index and based on the specified local space index, a local space-time; search for a point corresponding to the specified local space index; augment a feature vector of a point cluster; detect, based on the feature vector, the object; and control, based on the detected object, an autonomous driving operation of the vehicle.

### CROSS-REFERENCE TO RELATED APPLICATION

This application claims the benefit of and priority to Korean Patent Application No. 10-2025-0050387, filed in the Korean Intellectual Property Office on Apr. 17, 2025, the entire contents of which are incorporated herein by reference.

### TECHNICAL FIELD

The present disclosure relates to autonomous vehicles and more particularly to an artificial neural network system for recognizing a three-dimensional (3D) object.

### BACKGROUND

With the development and proliferation of autonomous vehicles, there has been an increase in variety of types of sensors being used and adoption of an artificial intelligence (AI) technology to support an autonomous driving function of the vehicle. For example, research continues on recognition of an object present in front of a moving vehicle, determining the distance between the object and the vehicle, and determining the algorithm to deploy according to each specific situation to ensure safety.

Thus, a vehicle sensor technology has become more advanced. There is a trend towards implementing high-performance sensors on vehicles, such as light detection and ranging (LiDAR) for recognizing a surrounding environment using laser beams, a radar using radio waves, an ultrasonic sensor, a fisheye camera capable of capturing a 360-degree image, a multifocal lens, and/or a global positioning system (GPS).

It is possible to aggregate the measurements obtained from the plurality of sensors to implement a so-called super sensor vehicle. The concept of a super sensor in self-driving vehicles or autonomous driving vehicles refers to a technology for combining measured values of various sensors to more accurately recognize a surrounding environment, rather than relying data from individual sensors separately, for convenience or safety of vehicle driving. As information and communications technology (ICT) and cloud technology are added to this, a sensor necessary for autonomous driving and an AI algorithm associated with it are becoming more advanced than ever. For example, data may be remotely collected from a fleet of vehicles, rather than from only one target vehicle, and may train an AI server and a database to increase the reliability of determination of the vehicle sensor.

Particularly, a 3D LiDAR sensor for recognizing an external environment may emit laser and measure the laser beam that is reflected from a surrounding object in terms of a time taken for reflection and laser intensity, thus recognizing various objects which are present on the road on which the vehicle is performing autonomous driving. However, object detection using the LiDAR and the AI algorithm may not always be accurate. Although the sensing technology of LiDAR and the AI technology continues to evolve, there exists a need to further advance the design of an artificial neural network system for more accurately recognizing an object.

The matters described in this Background section are only for enhancement of understanding of the background of the disclosure, and should not be taken as acknowledgement that they correspond to prior art already known to those skilled in the art.

### SUMMARY

The present disclosure has been made to solve the above-mentioned problems occurring in at least some implementations while advantages achieved by those implementations are maintained intact.

An aspect of the present disclosure provides an artificial neural network system for recognizing a 3D object based on accumulated sequence data and a method for implementing the same, and more particularly, provides an AI neural network system for recognizing an object based on AI and a 3D autonomous driving sensor to locally augment spatiotemporal feature information about the object.

The technical problems to be solved by the present disclosure are not limited to the aforementioned problems, and any other technical problems not mentioned herein will be clearly understood from the following description by those skilled in the art to which the present disclosure pertains.

The present disclosure may be implemented in the following various aspects to address all or at least some of the above-mentioned technical problems.

According to one or more example embodiments of the present disclosure, an apparatus of a vehicle may include: a three-dimensional (3D) sensor configured to obtain a plurality of point data associated with a surrounding environment of the vehicle; a memory configured to store the plurality of point data, obtained by the 3D sensor, as accumulated sequence data; and a processor. The accumulated sequence data may include a plurality of frames sequentially arranged in time. The processor may be configured to: specify, based on a predetermined local space configuration scheme, a local space index for performing an augmentation operation associated with an object, in the surrounding environment, that is recognized, based on the plurality of point data; initialize point spatiotemporal registration information of the accumulated sequence data; register, based on the local space index, the initialized point spatiotemporal registration information; search for a point corresponding to the specified local space index; specify, among the plurality of frames of the accumulated sequence data and based on a local time type corresponding to a predetermined local time configuration scheme, a frame index for performing the augmentation operation; determine a point index by searching for a point corresponding to the specified frame index; define, at the specified frame index and based on the specified local space index, a local space-time; search for a point corresponding to the specified local space index at the specified frame index to determine a local spatiotemporal feature of the point; augment, based on the determined local spatiotemporal feature, a feature vector of a point cluster associated with the local spatiotemporal feature; detect, based on the feature vector of the point cluster, the object in the surrounding environment of the vehicle; and control, based on the detected object, an autonomous driving operation of the vehicle.

The predetermined local time configuration scheme may be a divisor-based equal division scheme.

The predetermined local space configuration scheme may be at least one of: a voxelization-based local space configuration scheme or an exclusive clustering-based local space configuration scheme.

The processor may be further configured to: determine, before the point spatiotemporal registration information is initialized, the point spatiotemporal registration information according to an equation,

$$I = {\{ {\{ {I}_{n , m} \}}_{m = 1}^{{M}_{t - n}} \}}_{n = 0}^{N - 1} .$$

I may denote the point spatiotemporal registration information before initialization, n may denote a frame index indicating an acquisition time of a corresponding point in the accumulated sequence data, N may denote a quantity of the plurality of frames included in the accumulated sequence data, 0≤n≤N−1, m may denote an index indicating one of a plurality of points in a frame corresponding to n, t may denote a current time, Mₜ₋ₙ may denote a total quantity of points in point cloud data obtained at time t−n, and 1≤m≤Mₜ₋ₙ.

The processor may be configured to initialize the point spatiotemporal registration information by: determining the initialized point spatiotemporal registration information according to an equation,

$${I}^{1} = {\{ {\{ {I}_{n , m}^{1} \}}_{m = 1}^{{M}_{t - n}} \}}_{n = 0}^{N - 1} , {I}_{n , m}^{1} = [ n , m , - 1 ] ∈ {R}^{3} .$$

I¹ may denote the initialized point spatiotemporal registration information, and R³ may denote a 3D vector space.

The processor may be configured to register the initialized point spatiotemporal registration information by: determining the registered point spatiotemporal registration information according to an equation,

$${I}^{2} = {\{ {\{ {I}_{n , m}^{2} \}}_{m = 1}^{{M}_{t - n}} \}}_{n = 0}^{N - 1} {I}_{n , m}^{2} ∈ {R}^{3} .$$

I² may denote the registered point spatiotemporal registration information, n may denote a frame index indicating an acquisition time of a corresponding point in the accumulated sequence data, N may denote a quantity of the plurality of frames included in the accumulated sequence data, 0≤n≤N−1, m may denote an index indicating one of a plurality of points in a frame corresponding to n, t may denote a current time, Mₜ₋ₙ may denote a total quantity of points in point cloud data obtained at a time t−n, 1≤m≤Mₜ₋ₙ, and R³ may denote a 3D vector space.

The accumulated sequence data may be represented by equations,

$$\hat{P} = {\{ {\{ {\hat{p}}_{n , m} \}}_{m = 1}^{{M}_{t - n}} \}}_{n = 0}^{N - 1} , and$$

$${\hat{P}}_{n , m} = [ {x}_{n , m} , {y}_{n , m} , {z}_{n , m} , {r}_{n , m} , {\overline{t}}_{n , m} ] ∈ {R}^{5} .$$

\hat{P} may denote the accumulated sequence data, n may denote a frame index indicating an acquisition time of a corresponding point in the accumulated sequence data, N may denote a quantity of the plurality of frames included in the accumulated sequence data, 0≤n≤N−1, m may denote an index indicating one of a plurality of points in a frame corresponding to n, t may denote a current time, Mₜ₋ₙ may denote a total quantity of points in point cloud data obtained at time t−n, 1≤m≤Mₜ₋ₙ, Pnm may denote an initial feature vector for an m-th point in a (t−n)-th frame of the plurality of frames, the initial feature vector includes position information and a timestamp, and R⁵ may denote a five-dimension vector space having 3D coordinates (x,y,z), a lidar reflective index r, and a time offset t, relative to time t, as dimensions of the five-dimension vector space.

The accumulated sequence data after the feature vector of the point cluster associated with the local spatiotemporal feature is augmented may be represented by equations,

$$\tilde{P} = {\{ {\{ {\tilde{P}}_{n , m} \}}_{m = 1}^{{M}_{t - n}} \}}_{n = 0}^{N - 1} , and$$

$${\tilde{p}}_{n , m} = [ \begin{matrix}{x}_{n , m} , {y}_{n , m} , {z}_{n , m} , {r}_{n , m} , {\overline{t}}_{n , m} , {\overline{x}}_{n , m , 1} , {\overline{y}}_{n , m , 1} , {\overline{z}}_{n , m , 1} , \\ {\overline{x}}_{n , m , 2} , {\overline{y}}_{n , m , 2} , {\overline{z}}_{n , m , 2} , {\overline{x}}_{n , m , 3} , {\overline{y}}_{n , m , 3} , {\overline{z}}_{n , m , 3}\end{matrix} ] ∈ {R}^{14} .$$

\tilde{P} may denote the accumulated sequence data after the feature vector of the point cluster associated with the local spatiotemporal feature is augmented, n may denote a frame index indicating an acquisition time of a corresponding point in the accumulated sequence data, N may denote a quantity of the plurality of frames included in the accumulated sequence data, 0≤n≤N−1, m may denote an index indicating one of a plurality of points in a frame corresponding to n, t may denote a current time, Mₜ₋ₙ may denote a total quantity of points in point cloud data obtained at time t−n, 1≤m≤Mₜ₋ₙ, \tilde{p}_{n,m} may denote an augmented feature vector in which spatiotemporal feature information is augmented for an m-th point in a (t−n)-th frame, R¹⁴ may denote a fourteen-dimension vector space, and dimensions of the fourteen-dimension vector space include 3D coordinates (x,y,z), a lidar reflective index r, a time offset t̅, relative to time t, and feature information augmented at a first local time unit, a second local time unit, and a third local time unit in an m-th point obtained in a (t−n)-th frame for each of 3D coordinates.

\hat{P}_{n,s} may be a target of augmentation in the accumulated sequence data \hat{P}, s may be the local space index, \hat{P}_{n,s} may be a point set corresponding to a frame index among points constituting \hat{P}ₛ and \hat{P}_{n,s} ∈\hat{P}ₛ, and \hat{P}ₛ may be a point set included in an s-th local space among points constituting \hat{P} and \hat{P}ₛ ∈\hat{P}. Having a relationship of

$${\hat{P}}_{n , s} ∈ {\hat{P}}_{n , s}^{q}$$

including \hat{P}_{n,s} as a point set included in a same local space-time as \hat{P}_{n,s} in \hat{P}ₛ may be defined as

$${\hat{P}}_{n , s}^{q} .$$

The local space index s to which a point belongs may have a relationship of 1≤s≤S, and S may be a total quantity of local spaces for input data.

The processor may be configured to augment the feature vector of the point cluster by: determining, based on a plurality of point coordinates of the point cluster, arithmetic mean coordinates of the point cluster; and determining a deviation between points corresponding to the local space index and the frame index, respectively.

According to one or more example embodiments of the present disclosure, a method performed by an apparatus of a vehicle may include: obtaining, via a three-dimensional (3D) sensor of the vehicle, a plurality of point data associated with a surrounding environment of the vehicle; and storing the plurality of point data as accumulated sequence data. The accumulated sequence data may include a plurality of frames sequentially arranged in time. The method may further include: specifying, based on a predetermined local space configuration scheme, a local space index for performing an augmentation operation associated with an object, in the surrounding environment, that is recognized, based on the plurality of point data; initializing point spatiotemporal registration information of the accumulated sequence data; registering, based on the local space index, the initialized point spatiotemporal registration information; searching for a point corresponding to the specified local space index; specifying, among the plurality of frames of the accumulated sequence data and based on a local time type corresponding to a predetermined local time configuration scheme, a frame index for performing the augmentation operation; determining a point index by searching for a point corresponding to the specified frame index; defining, at the specified frame index and based on the specified local space index, a local space-time; searching for a point corresponding to the specified local space index at the specified frame index to determine a local spatiotemporal feature of the point; augmenting, based on the determined local spatiotemporal feature, a feature vector of a point cluster associated with the local spatiotemporal feature; detecting, based on the feature vector of the point cluster, the object in the surrounding environment of the vehicle; and controlling, based on the detected object, an autonomous driving operation of the vehicle.

The predetermined local time configuration scheme may be a divisor-based equal division scheme.

The predetermined local space configuration scheme may be at least one of: a voxelization-based local space configuration scheme or an exclusive clustering-based local space configuration scheme.

The method may further include: determining, before the initializing of the point spatiotemporal registration information, the point spatiotemporal registration information according to an equation,

$$I = {\{ {\{ {I}_{n , m} \}}_{m = 1}^{{M}_{t - n}} \}}_{n = 0}^{N - 1} .$$

I may denote the point spatiotemporal registration information before initialization, n may denote a frame index indicating an acquisition time of a corresponding point in the accumulated sequence data, N may denote a quantity of the plurality of frames included in the accumulated sequence data, 0≤n≤N−1, m may denote an index indicating one of a plurality of points in a frame corresponding to n, t may denote a current time, Mₜ₋ₙ may denote a total quantity of points in point cloud data obtained at time t−n, and 1≤m≤Mₜ₋ₙ.

Initializing the point spatiotemporal registration information may include: determining the initialized point spatiotemporal registration information,

$${I}^{1} = {\{ {\{ {I}_{n , m}^{1} \}}_{m = 1}^{{M}_{t - n}} \}}_{n = 0}^{N - 1} , {I}_{n , m}^{1} = [ n , m , - 1 ] ∈ {R}^{3} .$$

I¹ may denote the initialized point spatiotemporal registration information, and R³ may denote a 3D vector space.

Registering the initialized point spatiotemporal registration information may include: determining the registered point spatiotemporal registration information according to an equation,

$${I}^{2} = {\{ {\{ {I}_{n , m}^{2} \}}_{m = 1}^{{M}_{t - n}} \}}_{n = 0}^{N - 1} {I}_{n , m}^{2} ∈ {R}^{3} .$$

I² may denote the registered point spatiotemporal registration information, n may denote a frame index indicating an acquisition time of a corresponding point in the accumulated sequence data, N may denote a quantity of the plurality of frames included in the accumulated sequence data, 0≤n≤N−1, m may denote an index indicating one of a plurality of points in a frame corresponding to n, t may denote a current time, Mₜ₋ₙ may denote a total quantity of points in point cloud data obtained at a time t−n, 1≤m≤Mₜ₋ₙ, and R³ may denote a 3D vector space.

The accumulated sequence data may be represented by equations,

$$\hat{P} = {\{ {\{ {\hat{p}}_{n , m} \}}_{m = 1}^{{M}_{t - n}} \}}_{n = 0}^{N - 1} , and$$

$${\hat{p}}_{n , m} = [ {x}_{n , m} , {y}_{n , m} , {z}_{n , m} , {r}_{n , m} , {\overline{t}}_{n , m} ] ∈ {R}^{5} .$$

\hat{P} may denote the accumulated sequence data, n may denote a frame index indicating an acquisition time of a corresponding point in the accumulated sequence data, N may denote a quantity of the plurality of frames included in the accumulated sequence data, 0≤n≤N−1, m may denote an index indicating one of a plurality of points in a frame corresponding to n, t may denote a current time, Mₜ₋ₙ may denote a total quantity of points in point cloud data obtained at time t−n, 1≤m≤Mₜ₋ₙ, \hat{p}_{n,m} may denote an initial feature vector for an m-th point in a (t−n)-th frame of the plurality of frames, the initial feature vector includes position information and a timestamp, and R⁵ may denote a five-dimension vector space having 3D coordinates (x,y,z), a lidar reflective index r, and a time offset t̅, relative to time t, as dimensions of the five-dimension vector space.

The accumulated sequence data after the feature vector of the point cluster associated with the local spatiotemporal feature is augmented may be represented by equations,

$$\tilde{P} = {\{ {\{ {\tilde{P}}_{n , m} \}}_{m = 1}^{{M}_{t - n}} \}}_{n = 0}^{N - 1} , and$$

$${\tilde{p}}_{n , m} = [ \begin{matrix}{x}_{n , m} , {y}_{n , m} , {z}_{n , m} , {r}_{n , m} , {\overline{t}}_{n , m} , {\overline{x}}_{n , m , 1} , {\overline{y}}_{n , m , 1} , {\overline{z}}_{n , m , 1} , \\ {\overline{x}}_{n , m , 2} , {\overline{y}}_{n , m , 2} , {\overline{z}}_{n , m , 2} , {\overline{x}}_{n , m , 3} , {\overline{y}}_{n , m , 3} , {\overline{z}}_{n , m , 3}\end{matrix} ] ∈ {R}^{14} .$$

\tilde{P} may denote the accumulated sequence data after the feature vector of the point cluster associated with the local spatiotemporal feature is augmented, n may denote a frame index indicating an acquisition time of a corresponding point in the accumulated sequence data, N may denote a quantity of the plurality of frames included in the accumulated sequence data, 0≤n≤N−1, m may denote an index indicating one of a plurality of points in a frame corresponding to n, t may denote a current time, Mₜ₋ₙ may denote a total quantity of points in point cloud data obtained at time t−n, 1≤m≤Mₜ₋ₙ, \tilde{p}_{n,m} may denote an augmented feature vector in which spatiotemporal feature information is augmented for an m-th point in a (t−n)-th frame, R¹⁴ may denote a fourteen-dimension vector space, and dimensions of the fourteen-dimension vector space include 3D coordinates (x,y,z), a lidar reflective index r, a time offset t̅, relative to time t, and feature information augmented at a first local time unit, a second local time unit, and a third local time unit in an m-th point obtained in a (t−n)-th frame for each of 3D coordinates.

\hat{P}_{n,s} may be a target of augmentation in the accumulated sequence data \hat{P}, s may be the local space index, and \hat{P}_{n,s} may be a point set corresponding to a frame index among points constituting \hat{P}ₛ and \hat{P}_{n,s} ∈\hat{P}ₛ. \hat{P}ₛ may be a point set included in an s-th local space among points constituting \hat{P}ₛ and \hat{P}ₛ ∈\hat{P}. Having a relationship of

$${\hat{P}}_{n , s} ∈ {\hat{P}}_{n , s}^{q}$$

including \hat{P}_{n,s} as a point set included in a same local space-time as \hat{P}_{n,s} in \hat{P}ₛ may be defined as

$${\hat{P}}_{n , s}^{q} .$$

The local space index s to which a point belongs has a relationship of 1≤s≤S, and S may be a total quantity of local spaces for input data.

Augmenting the feature vector of the point cluster may include: determining, based on a plurality of point coordinates of the point cluster, arithmetic mean coordinates of the point cluster; and determining a deviation between points corresponding to the local space index and the frame index, respectively.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating the overall structure of an example system for controlling a vehicle to automatically recognize an object and perform autonomous driving;

FIG. 2 is a block diagram illustrating an example artificial neural network system for recognizing a 3D object based on accumulated sequence data;

FIG. 3 is a flowchart illustrating an example process of determining and augmenting local spatiotemporal feature information;

FIGS. 4A, 4B, and 4C are drawings illustrating various examples schemes for defining a “local time”;

FIGS. 5A and 5B are drawings illustrating example schemes for configuring a “local space”;

FIGS. 6A and 6B are drawings for describing an example process of searching for a point for a local space to perform augmentation and classifying the point for each local time type;

FIGS. 7A, 7B, and 7C are drawings for describing an example process of determining and augmenting local spatiotemporal feature information; and

FIG. 8 is a block diagram illustrating an example computing system for autonomous vehicle control and object detection computation.

### DETAILED DESCRIPTION

Hereinafter, one or more example embodiments of the present disclosure will be described in detail with reference to the drawings. In adding the reference numerals to the components of each drawing, it should be noted that the identical component is designated by the identical numerals even when they are displayed on other drawings. Further, in describing the example embodiment(s) of the present disclosure, a detailed description of well-known features or functions may be ruled out in order not to unnecessarily obscure the gist of the present disclosure.

In describing components of example embodiment(s) of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., computing and augmenting one or more local spatiotemporal features of an object in a surrounding environment) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., computing and augmenting one or more local spatiotemporal features of an object in a surrounding environment) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., computing and augmenting one or more local spatiotemporal features of an object in a surrounding environment) described herein.

Minimum risk maneuver (MRM) operation(s) may also be controlled, for example, based on one or more features (e.g., computing and augmenting one or more local spatiotemporal features of an object in a surrounding environment) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., computing and augmenting one or more local spatiotemporal features of an object in a surrounding environment) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., computing and augmenting one or more local spatiotemporal features of an object in a surrounding environment) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as 5 seconds, 30 seconds, 1 minute, etc.). By changing the required user attentiveness, the driver may be required to look ahead more often (e.g., at least once in a threshold time period, such as 5 seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., computing and augmenting one or more local spatiotemporal features of an object in a surrounding environment) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). One or more auxiliary devices (e.g., engine brake, exhaust brake, hydraulic retarder, electric retarder, regenerative brake, etc.) may also be controlled, for example, based on one or more features (e.g., computing and augmenting one or more local spatiotemporal features of an object in a surrounding environment) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., evaluating the engagement state of the driver) described herein.

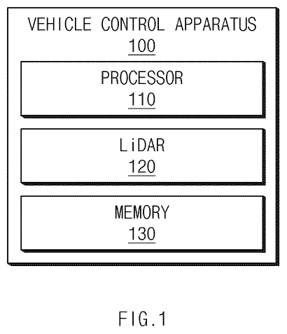

FIG. 1 is a block diagram illustrating the overall structure of an example system for controlling a vehicle to automatically recognize an object and perform autonomous driving.

Referring to FIG. 1, a vehicle control apparatus 100 may be implemented inside or outside a vehicle and some of the components included in the vehicle control apparatus 100 may be implemented inside or outside the vehicle. In this case, the vehicle control apparatus 100 may be integrally configured with control units in the vehicle or may be implemented as a separate device to be connected with the control units of the vehicle by a separate connection means. For example, the vehicle control apparatus 100 may further include components which are not shown in FIG. 1.

The vehicle control apparatus 100 may include a processor 110, light detection and ranging (LiDAR) 120, and a memory 130. The processor 110, the LiDAR 120, and the memory 130 may be electronically or operably coupled with each other by an electronical component including a communication bus.

Hereinafter, that pieces of hardware are operably coupled with each other may include that a direct connection or an indirect connection between the pieces of hardware is established wired and/or wirelessly, such that second hardware is controlled by first hardware among the pieces of hardware.

The different blocks are illustrated, but the present disclosure is not limited thereto. For example, some of the pieces of hardware of FIG. 1 may be included in a single integrated circuit including a system on a chip (SoC). Types of the pieces of hardware included in the vehicle control apparatus 100 and/or the number of the pieces of hardware are/is not limited to those shown in FIG. 1. For example, the vehicle control apparatus 100 may include only some of the pieces of hardware shown in FIG. 1.

The vehicle control apparatus 100 may include hardware for processing data based on one or more instructions. For example, the hardware for processing the data may include the processor 110. For example, the hardware for processing the data may include an arithmetic and logic unit (ALU), a floating point unit (FPU), a field programmable gate array (FPGA), a central processing unit (CPU), and/or an application processor (AP). The processor 110 may have a structure of a single-core processor or may have a structure of a multi-core processor including a dual core, a quad core, a hexa-core, or an octa core.

The processor 110 may include at least one of a graphic processing unit (GPU) or a neural processing unit (NPU), or any combination thereof. For example, the GPU may be referred to as a visual processing unit (VPU). For example, the NPU may be referred to as a neural network processing unit.

The vehicle control apparatus 100 may include a depth sensor for detecting an external object. For example, the depth sensor for detecting the external object may include at least one of a time of flight (ToF) sensor, the LiDAR 120, a structured light sensor, an ultrasonic sensor, an infrared radar, or an optical distance sensor, or any combination thereof. Hereinafter, a description will be given of LiDAR for convenience of description.

The vehicle control apparatus 100 may include the LiDAR 120 for obtaining a plurality of points based on a pulse laser signal. For example, the LiDAR 120 may obtain datasets for identifying a surrounding thing around the vehicle control apparatus 100 (or the vehicle including the vehicle control apparatus 100). For example, the LiDAR 120 may identify at least one of a position of the surrounding thing, a motion direction of the surrounding thing, or a speed of the surrounding thing, or any combination thereof, based on that a pulse laser signal radiated from the LiDAR 120 is reflected from the surrounding thing to return.

For example, the LiDAR 120 may obtain datasets representing an external object in a space formed by an x-axis, a y-axis, and a z-axis, based on the pulse laser signal reflected from the surrounding thing. For example, the LiDAR 120 may obtain datasets including a plurality of points in the space formed by the x-axis, the y-axis, and the z-axis, based on receiving the pulse laser signal at a specified period. For example, the plurality of points may include points representing the external object in a three-dimensional (3D) virtual coordinate system. The 3D virtual coordinate system may include at least one of a vehicle coordinate system or a LiDAR coordinate system, or any combination thereof. However, the example of the 3D virtual coordinate system is not limited to those described above.

The memory 130 of the vehicle control apparatus 100 may include a hardware component for storing data and/or an instruction input and/or output from the processor 110 of the vehicle control apparatus 100. For example, the memory 130 may include a volatile memory including a random-access memory (RAM) and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

One or more instructions indicating computation and/or an operation to be performed using data by the processor 110 of the vehicle control apparatus 100 may be stored in the memory 130 of the vehicle control apparatus 100. A set of the one or more instructions may be referred to as a program, firmware, an operating system, a process, a routine, a sub-routine, and/or an application.

As disclosed herein, the application being installed in the vehicle control apparatus 100 may mean that one or more instructions provided in the form of the application may be stored in the memory 130. In other words, the one or more applications may be stored in a format executable by the processor 110 of the vehicle control apparatus 100 (e.g., as a file with an extension specified by the operating system of the vehicle control apparatus 100).

For example, the memory 130 may include a first neural network model for detecting an object. For example, the memory 130 may include a second neural network model for outputting a type of the plurality of points obtained by the LiDAR 120 and/or a score of the plurality of points.

The processor 110 may obtain at least one of a first virtual box for representing a target object or a first class indicating a type of the target object, or any combination thereof, based on the plurality of points obtained via the LiDAR 120 and the first neural network model stored in the memory 130.

The processor 110 may obtain at least one of the first virtual box for representing the target object or the first class indicating the type of the target object, or any combination thereof, based on inputting the plurality of points to the first neural network model. For example, the first neural network model may include an object detection model. For example, the target object may include an external object located within a specified distance from the vehicle control apparatus 100 (or a host vehicle including the vehicle control apparatus 100). For example, the target object may include an object which is identified by the vehicle control apparatus 100 and is continuously tracked. For example, the type of the target object may include a plurality of types for classifying the target object. For example, the type of the target object may include at least one of a first type indicating the ground or a second type indicating a type different from the ground, or any combination thereof. However, the type of the target object is not limited to those described above. For example, the type of the target object may include, but is not limited to, at least one of a third type indicating a person or a fourth type indicating a vehicle, or any combination thereof.

The processor 110 may obtain at least one of first partial points corresponding to at least a portion of the target object among the plurality of points, based on the plurality of points and the second neural network model or a second class identified via the first partial points and indicating the type of the target object, or any combination thereof, based on the plurality of points and the second neural network model. For example, the second neural network model may include a segmentation model.

For example, the second neural network model may include a neural network model for obtaining the type of the plurality of points and the score of the plurality of points.

For example, the processor 110 may obtain the first partial points corresponding to the at least a portion of the target object among the plurality of points, based on inputting the plurality of points to the second neural network model. For example, the processor 110 may identify the type of the plurality of points, based on inputting the plurality of points to the second neural network model. For example, the processor 110 may obtain the first partial points corresponding to the at least a portion of the target object among the plurality of points, based on the type of each of the plurality of points.

The processor 110 may perform a first specified algorithm for the plurality of points. For example, the processor 110 may perform the first specified algorithm for classifying the type of each of the plurality of points, for the plurality of points. For example, the processor 110 may classify second partial points corresponding to a specified type among the plurality of points. For example, the specified type may include a type representing the ground.

For example, the processor 110 may classify the second partial points corresponding to the specified type, based on performing the first specified algorithm for the plurality of points, and may exclude the second partial points from the plurality of points to obtain (or identify) the first partial points.

The processor 110 may obtain at least one of a partial class for obtaining the second class, or the score of each of the plurality of points, or any combination thereof, based on inputting the plurality of points to the second neural network model. For example, the processor 110 may obtain the partial class and the score of each of the plurality of points, based on inputting the plurality of points to the second neural network model. For example, the partial class may include classifying each of the plurality of points as any type.

For example, the processor 110 may fuse the partial class, the score of each of the plurality of points, and the second partial points. For example, the processor 110 may perform clustering, based on fusing the partial class, the score of each of the plurality of points, and the second partial points. For example, the clustering may include grouping the first partial points corresponding to the at least a portion of the target object.

For example, the processor 110 may obtain a point cloud for generating a second virtual box, based on the first partial points. For example, the processor 110 may obtain the point cloud, based on grouping the first partial points.

For example, the processor 110 may generate the second virtual box which is different from the first virtual box and is for representing the target object, based on the point cloud. For example, the second virtual box may include a box including at least some of the first partial points.

For example, the processor 110 may identify a heading direction indicating a progress direction of the target object, based on at least one of the first partial points or the point cloud, or any combination thereof.

For example, the processor 110 may identify a position of the second virtual box on the virtual coordinate system, based on the at least one of the first partial points or the point cloud, or the any combination thereof. For example, the processor 110 may identify a size of the second virtual box, based on the at least one of the first partial points or the point cloud, or the any combination thereof. For example, the processor 110 may identify a second class, based on the at least one of the first partial points or the point cloud, or the any combination thereof. For example, the processor 110 may identify at least one of the heading direction indicating the progress direction of the target object, the position of the second virtual box on the virtual coordinate system, the size of the second virtual box, or the second class, or any combination thereof, based on the at least one of the first partial points or the point cloud, or the any combination thereof. For example, the processor 110 may identify a heading direction of a bounding box, based on at least one of the first virtual box, the first class, the heading direction of the second virtual box, the position of the second virtual box, the size of the second virtual box, or the second class, or any combination thereof. For example, the processor 110 may identify a position of the bounding box on the virtual coordinate system, based on the at least one of the first virtual box, the first class, the heading direction of the second virtual box, the position of the second virtual box, the size of the second virtual box, or the second class, or the any combination thereof. For example, the processor 110 may obtain a third class indicating the type of the target object corresponding to the bounding box, based on the at least one of the first virtual box, the first class, the heading direction of the second virtual box, the position of the second virtual box, the size of the second virtual box, or the second class, or the any combination thereof. For example, the processor 110 may obtain at least one of the heading direction of the bounding box, the position of the bounding box on the virtual coordinate system, or the third class indicating the type of the target object corresponding to the bounding box, or any combination thereof, based on the at least one of the first virtual box, the first class, the heading direction of the second virtual box, the position of the second virtual box, the size of the second virtual box, or the second class, or the any combination thereof.

For example, the processor 110 may assign a first identifier for tracking the second virtual box to the second virtual box. For example, the processor 110 may assign a second identifier corresponding to the first identifier to the bounding box.

For example, the processor 110 may track the bounding box using the second identifier. For example, the processor 110 may track the target object, based on identifying a plurality of bounding boxes including the bounding box to which the second identifier is assigned, at a plurality of frames. For example, because the second identifier is an identifier assigned to the bounding box corresponding to the target object, the processor 110 may identify the plurality of bounding boxes to which the second identifier is assigned, at the plurality of frames, to track the target object.

The processor 110 may output the bounding box corresponding to the target object, based on at least one of the first virtual box, the first class, the first partial points, or the second class, or any combination thereof. For example, the bounding box may include an example of representing the target object on the virtual coordinate system in the form of a hexahedron.

Hereinafter, a description will be given briefly of operations performed by the CPU, the GPU, and/or the NPU included in the processor 110.

The processor 110 may include at least one of the CPU, the GPU, or the NPU, or any combination thereof. For example, at least one of the GPU or the NPU, or any combination thereof may obtain the first virtual box and the first class, based on the first neural network model. For example, at least one of the GPU or the NPU may obtain the first virtual box and the first class. For example, the at least one of the GPU or the NPU, or the any combination thereof may obtain the partial class for obtaining the second class and the score of each of the plurality of points, based on the second neural network model. For example, the at least one of the GPU or the NPU may obtain the partial class for obtaining the second class and the score of each of the plurality of points, based on the second neural network model. For example, the CPU may classify the second partial points corresponding to the specified type among the plurality of points, based on performing the first specified algorithm for classifying the type of each of the plurality of points, for the plurality of points.

As described above, the vehicle control apparatus 100 may include the at least one processor 110. The vehicle control apparatus 100 may detect the target object using the at least one processor 110 to accurately detect the target object. Furthermore, by performing a parallel process, the vehicle control apparatus 100 may reduce a load for each processor.

An object detection-related description based on LiDAR may be added for the overall understanding of AI object detection according to the present disclosure as follows.

An object detection process based on the LiDAR 120 or the AI module passes through three steps, such as pre-processing, segmentation, and tracking.

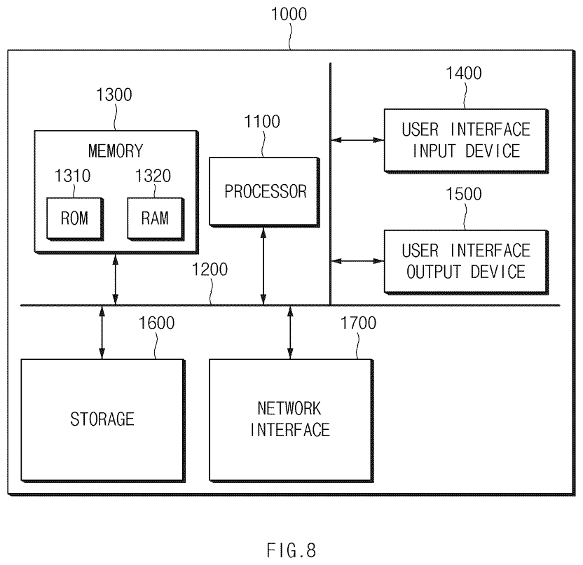

The object recognition system 1000 (refer to FIG. 8) according to the present disclosure may pass through pre-processing before executing an object detection function. The pre-processing may include, for example, an operation of removing points forming the ground, based on laser sensing data (e.g., raw data) input from the LiDAR 120. Because it is able to be misrecognized as if there is any object on the ground by a laser beam reflected from the ground, the process of separating the ground from a thing which is not the ground may be performed in the pre-processing step and may also be performed in the segmentation step if necessary.

For example, the pre-processing in AI object detection is understood as a process in which an image processing tool of the AI module in the processor 110 removes noise of a LiDAR point cloud image, for example, reduces the total number of points which are present in the LiDAR point cloud image via a voxel downsampling technique or the like to promote computational efficiency.

For reference, the LiDAR point cloud image may be displayed in a bird's eye view (BEV) scheme. If a LiDAR map is generated as if it were a bird's eye view of the city while the bird flies in the sky, this is referred to as a BEV image.

In other words, as described above, the LiDAR 120 transmits a laser beam to a surrounding environment and records a time when the laser beam is reflected from an object which is present in the outside to return, thus generating a point every many laser signals and determining (e.g., calculating) a distance to the point. By repeatedly transmitting many laser beams, the processor 110 may generate a real-time LiDAR map for the surrounding environment as a BEV type of 3D map and may generate the real-time LiDAR map as a two-dimensional (2D) map if necessary.

The line or surface shown in black and white on the LiDAR point cloud map is actually composed of innumerable points (each of which is generated by the laser beam of the LiDAR 120). Due to this, a LiDAR sensing image is called a LIDAR point cloud image. For example, if a red, green, blue-depth (RGB-D) sensor and the LiDAR sensor are combined with each other, the LiDAR point cloud image may be re-implemented in color.

If it is difficult for humans to recognize a thing using only one of many points in the LiDAR point cloud image, but, for example, if they synthetically look at the point cloud from the BEV's point of view or in the same way as a 2D floor plan, they may roughly guess whether the surrounding environment around the vehicle which is currently performing autonomous driving is any shape. In addition, for example, it is possible to recognize a vehicle, a bus, a pedestrian, a street tree, a traffic sign, or the like which is present in the LiDAR point cloud image. Such a thing or person is called an object in an AI image recognition technology. It is possible to classify the object as a class which belongs to a group of the specific nature, such as a vehicle class or a bus class.

The help of a deep AI neural network is required to classify whether any object in the LiDAR point cloud image is the vehicle class or the bus class. AI training should precede to find objects in the LiDAR point cloud image via the AI neural network and identify a class of the object.

For example, a dataset (source: https://pandaset.org/#data-collection) called PANDASET™ includes more than 48,000 camera images (images captured primarily in the Silicon Valley region of the United States) and includes more than 16,000 LiDAR scam images. A total of 28 classes, such as pedestrians, cars, bicycles, construction site signs, and traffic signs, are arranged in the form of an annotation in these images.

Furthermore, the LiDAR point cloud image may be visualized to suit an option desired by the user using a point cloud working tool, such as Open3D® (source: https://www.open3d.org/). Because the LiDAR 120 is able to detect a distance, it may more realistically reproduce a 3D LiDAR image in such a manner as to display a thing in a long distance in, for example, a deep blue and display a thing in a short distance in a light blue, if the LiDAR point cloud image is visually processed using, for example, Open3D™.

In addition, as described above, the technology, for example, voxel (3D pixel) downsampling, may be applied to the LiDAR point cloud image to pre-process an original LiDAR image (e.g., raw data). Herein, the voxel refers to a 3D pixel in the shape of a regular hexahedron and the voxel downsampling is a technology for reducing the number of points not to require excessive AI computation, even while maintaining a structure of various objects included in the LiDAR point cloud.

The LiDAR 120 radiates, for example, m laser beams n times during one scan cycle. In this case, the scan value of the laser beam which collides with an external object to return constitutes an (m×n) matrix. This (m×n) matrix data is called a range image. Each point constituting the LiDAR point cloud image may include depth (e.g., range) information and may further include intensity, an azimuth, an inclination, or the other additional information of the returned laser pulse. The range image is a large amount of datasets, for example, Waymo™ open dataset (WOD). It is possible to perform AI learning of the range image.

A range view (RV) refers to a technique for converting a 3D point cloud into a 2D scene, for example, a 2.5D scene to represent the 3D point cloud as a 3D LiDAR map that humans are able to intuitively understand, like an analog picture, rather than a large number of points. The 3D LiDAR point cloud image has 2D coordinates in the range view image, but the 3D laser-related information (e.g., the angle, the inclination, the intensity, and the like) which is recorded when previously obtaining the range image is not discarded. If a variable called a width is applied to (x, y) coordinates among (x,y,z) coordinate values of the 3D LiDAR image to obtain a coordinate on one axis in two dimensions and range image information indicating a range (depth) and a variable called a height are applied to the (z) coordinate to obtain a coordinate of the other axis in two dimensions, this is generated as a 2D range view image.

In addition, the AI algorithm according to the present disclosure may include a convolutional neural network (CNN). The CNN is an AI training module frequently used to extract a feature (or a feature point) from image data. To this end, there is a dataset composed of tens of thousands of commercially available images. The CNN currently has a version capable of processing each of one-dimensional to three-dimensional images. In other words, the result of a range view image processing tool is learned by the CNN to perform a function of helping AI to accurately recognize an object in an image.

Because a thing present around an autonomous vehicle is recognized by a machine, the operation of generating a ground truth (GT) bounding box on the above-mentioned LiDAR map may be also an important process in object detection. Ground truth (GT) in machine learning is a term used when indicating an original value and a real value of data AI wants to learn. It may be usually viewed as a kind of image annotation overlaid on the LiDAR point cloud image as a bounding box with a box-shaped boundary.

In other words, the AI module fetches a label to group various objects to recognize the object. An interval of 3D data points used to output a GT bounding box may be set, which may be set such that about 50 to 1000 LiDAR point cloud points are included in one GT bounding box.

There may be no GT annotation in original data (or raw data) captured by the sensor, such as the LiDAR 120, while the vehicle is driving. The processor 110 should recognize a target which belongs to various classes, such as a road sign of the road, a crosswalk, a pedestrian, the other vehicle, and a center line, as an object. The GT annotation is a means used to compare the result of determining the object recognized by the AI algorithm of the processor 110 with the reality to measure an error in object detection and evaluate AI performance sometimes. A GT bounding box overlaid on the original image in the form of an annotation may be set manually by the user, but there is representatively a commercially available GT computation tool, such as grid-striding.

If the AI object detection module is driven, a predicted bounding box may be checked. The result of being recognized as an object of a specific class by the processor 110 from the original image data obtained from the LiDAR 120 or the like is represented in the form of another bounding box similar to the GT bounding box. Unlike the GT bounding box, the predicted bounding boxes are the result of being determined (e.g., calculated) by autonomous driving AI. The predicted bounding box may be identical to the GT bounding box, but may fail to be identical to the GT bounding box or may not at all have a region where the predicted bounding box and the GT bounding box overlap with each other.

For reference, because it is unable to conclude that an object of a specific class is actually present at a certain position definitely using only predicted bounding boxes, the predicted bounding boxes are usually called probability boxes (P-Boxes) or predicted bounding boxes.

Segmentation processing performed after the pre-processing refers to displaying a specific portion (e.g., traffic lights) of the road in, for example, red and displaying the rest (bituminous road) in blue. Clustering the point cloud into a certain group and generating a P-Box may be performed in the segmentation step. For reference, there is a technology called cluster expansion. Herein, an expansion target may include a cluster up to a seed point and all points within an epsilon distance (the minimum distance constituting the cluster).

Clustering based on the point cloud and P-Box generation proceed upon the segmentation processing. For example, an AI network which performs segmentation is used to obtain a point label from the LiDAR 120.

The present disclosure proposes a “rule-based” road surface recognition and label fusion technique to solve a ground surface recognition error problem which occurs upon segmentation. It is fine that any of various techniques, such as road surface recognition based on a slope, grid-based road surface recognition, and the other non-planar based road surface recognition, is representatively applied to the road surface recognition algorithm. However, the present disclosure proposes adopting a slope-based road surface recognition technique, if recognizing a road surface in a tunnel.

For reference, semantic segmentation is a task for attaching a unique class label to respective points in the point cloud generated by the LiDAR 120. The semantic segmentation in a LiDAR imaging technology is a technology for finding and using meaningful information from LiDAR data for object detection or scene representation necessary to implement autonomous driving. There are already various semantic segmentation AI models, such as a projection-based method, a point-based method, and a sparse convolution-based method. For example, the semantic segmentation result may be the AI computation result performed together with the NVIDIA DRIVE™ AGX system by the processor 110. Via such a configuration, various colors may be added to, for example, the LiDAR point cloud image.

The LiDAR image passes through the process called post-processing after the segmentation process. The post-processing refers to converting point cloud data into a 3D map or modeling, which is information meaningful for autonomous driving. A process of removing noise of the LiDAR point cloud image or an error in the LiDAR point cloud image, recognizing an object, such as a vehicle or a pedestrian, from the point cloud, and attaching and registering a unique identifier to the point cloud information if necessary is also included in the post-processing.

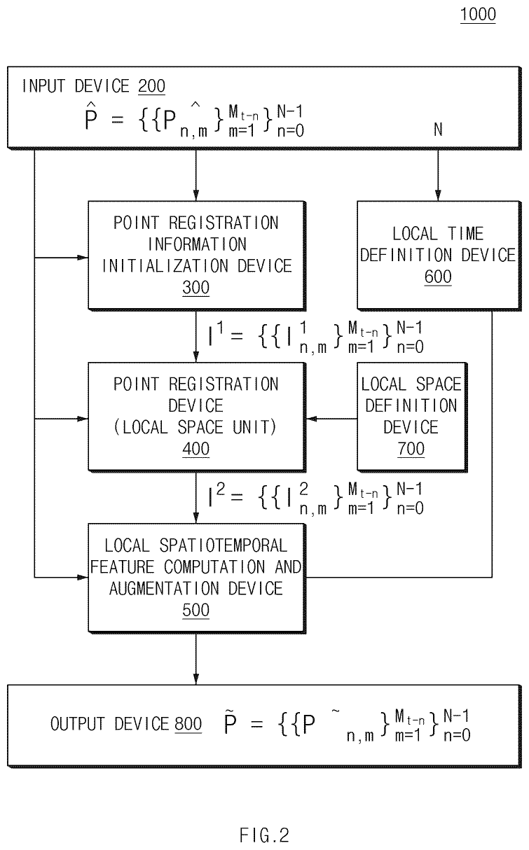

FIG. 2 is a block diagram illustrating an example artificial neural network system 1000 for recognizing a 3D object based on accumulated sequence data. The artificial neural network system 1000 according to the present disclosure may correspond to a computing system 1000 of FIG. 8, which will be described below. An AI module according to the present disclosure may be loaded into a processor 110 of FIG. 1 to operate as software. Various point clouds input from LIDAR 120 and accumulated data thereof for each frame may be stored in a memory 130 and may be used if necessary by the AI module.

Referring to FIG. 2, an input device 200 included in the system 1000 according to the present disclosure may input

$$\hat{P} = {\{ {\{ {\hat{p}}_{n , m} \}}_{m = 1}^{{M}_{t - n}} \}}_{n = 0}^{N - 1} .$$

This may be N-frame point cloud data accumulated on the basis of current time point t, which may actually correspond to an output of a point cloud sequence accumulation system (not shown) which is not shown in FIG. 2. Herein, it is understood that

$${\{ {\hat{P}}_{0 , m} \}}_{m = 1}^{{M}_{t}}$$

is point cloud data obtained at time point t, there is Pₜ which does not pass through separate transformation, and

$${\{ {\{ {\hat{p}}_{n , m} \}}_{m = 1}^{{M}_{t - n}} \}}_{n = 1}^{N - 1}$$

is (N−1)-frame point cloud data at a past time point, the position of which is transformed on the basis of time point t via vehicle movement information

$${\{ {D}_{t - n} \}}_{n = 1}^{N - 1} .$$

Herein, for the vehicle movement information, K is the length of the point cloud data stored in the memory 130 (e.g., the length of the frame),

$${\{ {P}_{t - k} \}}_{k = 1}^{K}$$

is the K-frame point cloud data obtained at the past time point, and

$${\{ {D}_{t - k} \}}_{k = 1}^{K}$$

is the vehicle movement information between the K-frame adjacent frames obtained in the past. Furthermore, Pₜ is the single-frame point cloud data obtained at current time point t, N is the point cloud sequence length to be accumulated as the total number of frames and has the relationship ((N−1)≤K), Mₜ₋ₙ is the total number of points included in the (t−n)-th frame point cloud data, and the input

$$\hat{P} = {\{ {\{ {\hat{p}}_{n , m} \}}_{m = 1}^{{M}_{t - n}} \}}_{n = 0}^{N - 1}$$

by the input device 200 is the point cloud sequence data accumulated on the basis of time point t.

For reference, \hat{p}_{n,m} is the initial feature vector for the m-th point of the (t−n)-th frame and is the feature vector including default information, such as position information and a timestamp. \tilde{P} which is a final output by the output device 800 may be the accumulated point cloud sequence data in which the local spatiotemporal information as

$$\tilde{P} = {\{ {\{ {\tilde{p}}_{n , m} \}}_{m = 1}^{{M}_{t - n}} \}}_{n = 0}^{N - 1}$$

is augmented. Herein, \tilde{p}_{n,m} is the feature vector in which the spatiotemporal feature information about the m-th point of the (t−n)-th frame is augmented. Thus, the total input to the above-mentioned point cloud sequence accumulation system (not shown) is the point cloud data Pₐ (e.g., the point cloud data obtained at time point a from the autonomous driving sensor 120),

$${\{ {P}_{t - k} \}}_{k = 1}^{K} ,$$

that is, the K frame point cloud data obtained at the past time point and stored in the memory 130, Pₜ, that is, the point cloud data obtained at current time point t, the vehicle movement information Da, that is, the vehicle movement information which occurs between time point a and time point (a+1), a frame length N, and the like.

The vehicle behavior information required to accumulate the past time point point cloud data on the basis of the current time point by the cloud sequence accumulation system (not shown) is

$${\{ {D}_{t - k} \}}_{k = 1}^{K} ,$$

that is, the vehicle behavior information between adjacent frames and is determined (e.g., calculated) from a controller for vehicle dynamics signal processing or the like.

In detail, the above-mentioned accumulated sequence length N is a point cloud sequence length, representing a frame unit, to be accumulated and used in a cognitive system, which accumulates and merges sequence data of all N frames including current time point t.

A total output by the point cloud sequence accumulation system (not shown) (e.g., an input to the input device 200) is N-frame point cloud data

$$\tilde{P} = {\{ {\{ {\tilde{p}}_{n , m} \}}_{m = 1}^{{M}_{t - n}} \}}_{n = 0}^{N - 1}$$

or the like in which the sequence length N used to accumulate data in the entire system and feature information determined (e.g., calculated) based on the defined local space-time are augmented. \hat{P} delivered as a system input via spatiotemporal feature information augmentation and the total number of points are identical to each other. A dimension number of a feature vector representing each single point increases.

Data before augmentation of the m-th single point vector of the (t−n)-th frame may be represented as \hat{P}_{n,s} ∈R^{l}. Data after augmentation of the m-th single point vector of the (t−n)-th frame (data treated in the step of the output device 800 of FIG. 2) may be represented as \tilde{p}_{n,m}∈R^{d} (d>l).

A local time definition device 600 and a local space definition device 700 in FIG. 2 may be seen as a so-called static sub-system, which may refer to a sub-system, that is, a device in which a local space definition scheme and a local time definition scheme used in the present disclosure are statically defined, regardless of accumulated point cloud data received as a real-time input (or dynamic input data).

The local space definition device 700 may be a sub-system of the present disclosure, which stores a local space configuration scheme. The local time definition device 600 may be a sub-system of the present disclosure, which stores a local time configuration scheme based on the sequence length N.

A point registration information initialization device 300, a point registration device 400, and a local spatiotemporal feature computation and augmentation device 500 shown in FIG. 2 may be a so-called dynamic sub-system.

The point registration information initialization device 300 may be a component for initializing “spatiotemporal point registration information” for each single point in the accumulated point cloud data. The initialized spatiotemporal point registration information may be referred to as I¹ in the present disclosure.

The point registration device 400 may be a device for registering a point in units of a local space, which may be a component for dividing the accumulated point cloud data Pin units of a local space depending on the “local space configuration scheme” delivered from the local space definition device 700. In other words, an algorithm for indexing which local space it is included in for each single point in the accumulated point cloud may be performed by the point registration device 400. Spatiotemporal point registration information in which the local space index is updated may be I². I² may be the output of the point registration device 400.

The local spatiotemporal feature computation and augmentation device 500 may determine (e.g., calculate) point cloud-based feature information included in the same local space-time with reference to I² with spatiotemporal registration information for each single point and the “local time configuration scheme” (also referred to as localized time configuration scheme) used in the present disclosure. Furthermore, the local spatiotemporal feature computation and augmentation device 500 may augment the calculated spatiotemporal feature information to a feature vector of points which fit a condition. If data before augmentation of the m-th single point vector of the (t−n)-th frame is \hat{P}_{n,s} ∈R^{l}, data after augmentation of the m-th single point vector of the (t−n)-th frame may be represented as \tilde{p}_{n,m}∈R^{d} (d>l).

In other words, an AI module included in the system 1000 according to the present disclosure may include a memory for storing a plurality of pieces of point data input from a 3D autonomous driving sensor 120 as accumulated sequence data including a plurality of frames accumulated in units of time and a frame. The AI module may interwork with the local spatiotemporal feature computation and augmentation device 500 to execute a step of specifying a local space index to perform the augmentation operation based on a certain local space configuration scheme and initializing and registering spatiotemporal registration information of the accumulated sequence data point based on the local space index s, a step of searching for a point corresponding to the specified local space index, a step of specifying a frame index n to perform the augmentation operation among a plurality of pieces of sequence data, which is input from the 3D autonomous driving sensor and includes a frame accumulated for each time, based on a local (e.g., localized) time type q (which is present from q₁ to q_{Q}) according to a certain local time configuration scheme, a step of searching for a point corresponding to the specified frame index and setting a point index m, a step of defining a local space-time based on the specified local space index at the specified frame index and searching for a point corresponding to the specified frame index at the specified local space index to calculate a local spatiotemporal feature of the point, and a step of augmenting a feature vector of a point cluster associated with the local spatiotemporal feature based on the calculated local spatiotemporal feature. Such steps may be executed in the system 1000 shown in FIG. 2 or in a cloud scheme sometimes.

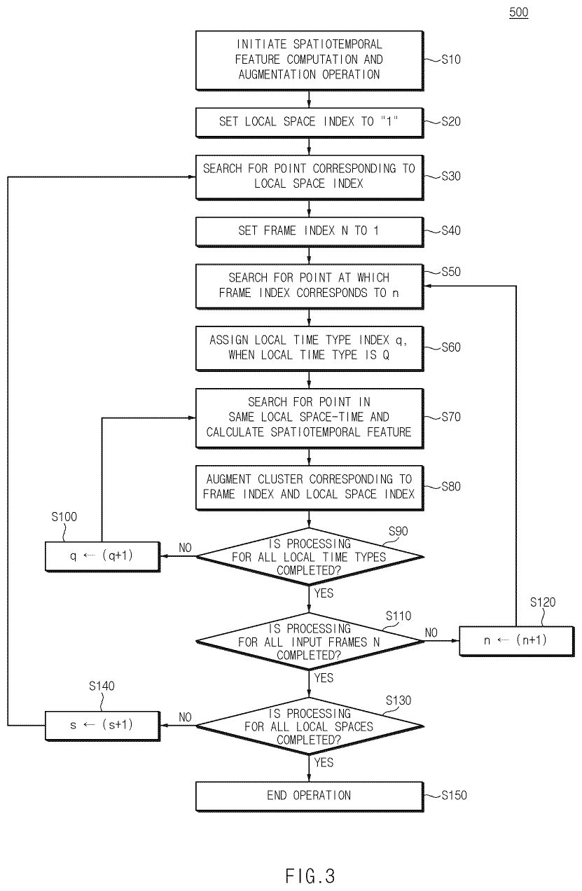

The above algorithm may be actually performed in the local spatiotemporal feature computation and augmentation device 500 of the present disclosure. FIG. 3 illustrates in detail the above process.

FIG. 3 is a flowchart illustrating an example process of determining and augmenting local spatiotemporal feature information.

In S10, a local spatiotemporal feature computation and augmentation device 500 may I initiate a spatiotemporal feature computation and augmentation operation. In S20, the local spatiotemporal feature computation and augmentation device 500 may set a local space index to “1”. In S30, the local spatiotemporal feature computation and augmentation device 500 may search for a point corresponding to the local space index. In S40, the local spatiotemporal feature computation and augmentation device 500 may set the point information to “1”.

In S50, the local spatiotemporal feature computation and augmentation device 500 may search for a point at which the frame index corresponds to n. In S60, the local spatiotemporal feature computation and augmentation device 500 may assign a local time type index q, when a local time type is Q.

In S70, the local spatiotemporal feature computation and augmentation device 500 may search for a point in the same local space-time and may determine (e.g., calculate) a spatiotemporal feature. In S80, the local spatiotemporal feature computation and augmentation device 500 may augment a cluster corresponding to a frame index and a local space index. In S90, the local spatiotemporal feature computation and augmentation device 500 may check whether processing for all local time types is completed. In S110, the local spatiotemporal feature computation and augmentation device 500 may check whether processing for all input frames N is completed. In S130, the local spatiotemporal feature computation and augmentation device 500 may check whether processing for all local spaces is completed. The local spatiotemporal feature computation and augmentation device 500 may repeat the process until completing augmentation processing for a next local time (e.g., S100), a next frame (e.g., S120), a next local space (e.g., S140), upon NO determination in S90, S110, and S130.

In S150, the local spatiotemporal feature computation and augmentation device 500 may end the operation and may output

$$\tilde{P} = {\{ {\{ {\tilde{p}}_{n , m} \}}_{m = 1}^{{M}_{t - n}} \}}_{n = 0}^{N - 1}$$

as described above.

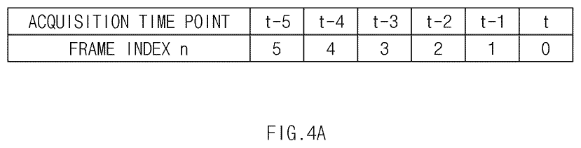

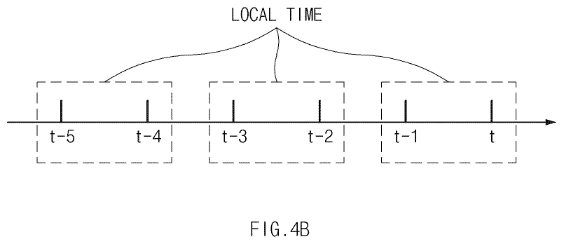

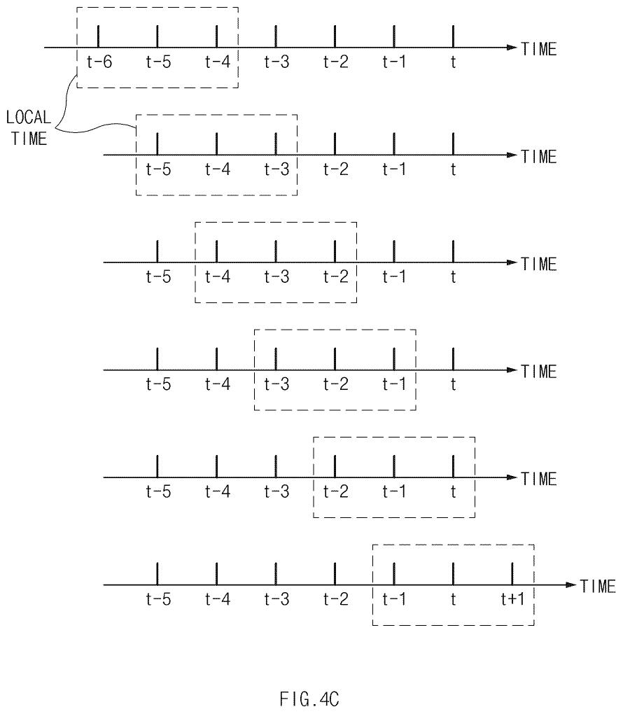

FIGS. 4A to 4C are drawings illustrating various examples schemes for defining a “local time.”

FIG. 4A illustrates a relationship between an acquisition time point and a frame index for describing a “local time configuration scheme” according to the present disclosure. For example, if there are a total of 6 frames where N=6 and current time point t is 0, a frame index number at time point t-5 is 5 and time points t-4, t-3, t-2, t-1, and t and frame index numbers correspond to each other in an order in which the frame index numbers are 4, 3, 2, 1, and 0.

A local time used in the present disclosure is illustratively described in FIG. 4B. In other words, the local time refers to a set of multiple acquisition time points composed of any data acquisition time point and an acquisition time point adjacent to the time point. Because data obtained at time point t is referred to as t-th frame data in the present disclosure, a local time configuration scheme is able to be variously applied to multiple frame data constituting an accumulated sequence using a sub-system (e.g., a local time definition device 600 of FIG. 2) which stores the local time configuration scheme.

Particularly, the present disclosure proposes that the local time configuration scheme is a divisor-based equal division scheme. In other words, the equal division scheme based on a divisor of a sequence length is introduced to configure a local time. For example, the appearance representing a 3-frame local time in a sliding window scheme, if N=6, may be checked in FIG. 4C.

If the accumulated sequence is equally divided into a length corresponding to the divisor of the sequence length, a set of the respective divided multiple time points may be defined as a local time. For example, equally dividing the accumulated sequence length of 6 into 2 frames to configure a local time is FIG. 4B and equally dividing the accumulated sequence length of 6 into 2 frames to configure a local time based on a sliding window is FIG. 4C. In FIG. 4C, a set of time points composed of a reference time point and time points before and after the time point may be defined as a local time and all time points in the accumulated sequence may be used as reference time points using a 3-frame sliding window to configure a local time.

For example, the local time definition device 600 may be a sub-system which stores the local time type described in FIGS. 4A to 4C, which may store the local time type based on the local time configuration scheme. Several local time types may be able to be derived for the same local time configuration scheme. Some thereof may be selectively used.

For reference, it is assumed that all the number of the local time types used in the system of the present disclosure is indicated as Q and at least one local time is used based on the local time configuration scheme. Thus, Q is an integer greater than “0”. For example, if the accumulated sequence length is 6, because 2, 3, and 6 except for 1 among divisors of 6 are able to be lengths constituting the local time, a maximum of 3 types of local time types may be derived.

A local space definition device 700 according to the present disclosure may be a sub-system of the present disclosure, which stores the “local space configuration scheme”, which may define a subspace capable of binding point clouds which are spatially adjacent to each other into one set, may include any point in accumulated sequence data in any local space, and may process one point not to be included in two different local spaces.

The local space configuration scheme may be variously applied to multiple frame data constituting the accumulated sequence. The present disclosure proposes one of a voxelization technique and an exclusive clustering technique in the local space definition device 700.

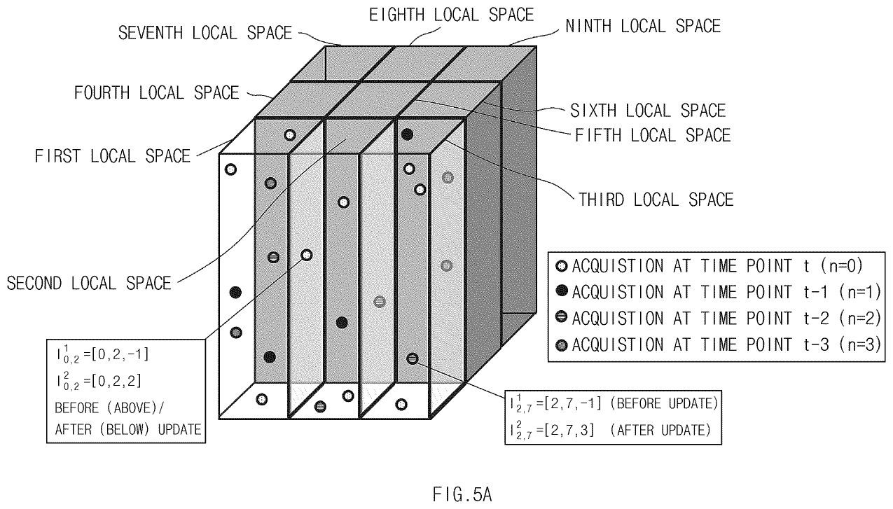

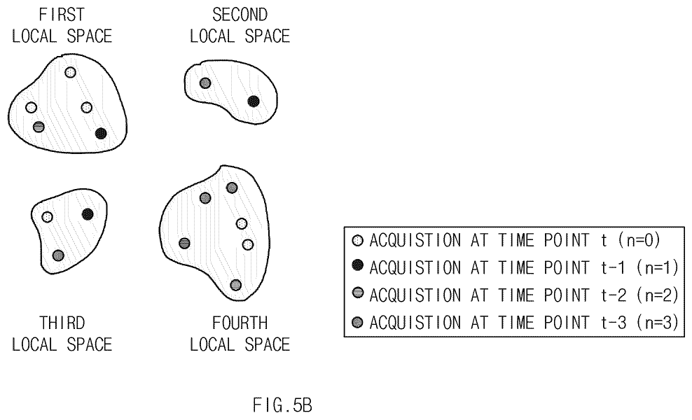

Herein, a description will be given with reference to FIG. 5A. FIGS. 5A and 5B are drawings illustrating example schemes for configuring a “local space.”

FIG. 5A illustrates an example according to a local space configuration scheme if N=4. FIG. 5B illustrates an example of a local space configuration (S=4 in the example) based on exclusive clustering.

For reference, an initial registration information vector for a second point of data at time point t (e.g., a frame index of 0) may be represented as

$${I}_{0 , 2}^{1} = [ 0 , 2 , - 1 ] ∈ {R}^{3} .$$

An initial registration information vector for a seventh point of data at time point (t-2) (e.g., a frame index of 2) may be represented as, for example,

$${I}_{2 , 7}^{1} = [ 2 , 7 , - 1 ] ∈ {R}^{3} .$$

However, vectors output by a point registration device 400 of FIG. 2 may be indicated as

$${I}_{0 , 2}^{1} = [ 0 , 2 , 2 ] ∈ {R}^{3} and {I}_{2 , 7}^{2} = [ 2 , 7 , 3 ] ∈ {R}^{3}$$

“After update” in FIG. 5A indicates a vector immediately output by the point registration device 400. For example, if a local space index for a system which uses a frame with an accumulated sequence length of 4 is updated, a second point of data at time point t (frame index: 0) and a seventh point of data at time point t (frame index: 2) are indicated as shown in FIG. 5A.

For example, it is indicated that all of s local spaces are generated when any local space generation scheme is applied to a space of input data (or accumulated sequence data) treated in the entire system. At this time, s has an integer value greater than “0”. In other words, a local space index s to which a point belongs has a relationship of 1≤s≤S (here, S is the total number of local spaces for input data).

In other words, the initialized point spatiotemporal registration information I¹ has a relationship of

$${I}^{1} = {\{ {\{ {I}_{n , m}^{1} \}}_{m = 1}^{{M}_{t - n}} \}}_{n = 0}^{N - 1} , {I}_{n , m}^{1} = [ n , m , - 1 ] ∈ {R}^{3} .$$

Herein, R³ denotes a 3D vector space. The point spatiotemporal registration information I² registered based on the local space index s has a relationship of

$${I}^{2} = {\{ {\{ {I}_{n , m}^{2} \}}_{m = 1}^{{M}_{t - n}} \}}_{n = 0}^{N - 1} , {I}_{n , m}^{2} ∈ {R}^{3} .$$

The point spatiotemporal registration information is

$$I = {\{ {\{ {I}_{n , m} \}}_{m = 1}^{{M}_{t - n}} \}}_{n = 0}^{N - 1} ,$$

which is assigned for each single point and is composed of the following 3 pieces of information as corresponding registration information I_{n,m}=[n,m,s]∈R³. In other words, the 3 pieces of information may be, first, a frame index n, 0≤n≤N−1 for providing a notification of an acquisition time point in an accumulated sequence, secondly, a point index m in data corresponding to the frame index n, and thirdly, 1≤m≤Mₜ₋ₙ (however, Mₜ₋ₙ is the total number of points of point cloud data obtained at time point (t−n)).

An initialization method by a point registration information initialization device 300 may be to initialize local space index information corresponding to a third dimension of a registration information vector as “−1”. In this case, it may be indicated that

$${I}^{1} = {\{ {\{ {I}_{n , m}^{1} \}}_{n = 0}^{{M}_{t - n}} \}}_{n = 0}^{N - 1} , {I}_{n , m}^{1} = [ n , m , - 1 ] ∈ {R}^{3} .$$

A point registration device 400 may update (e.g., register) local space information about a single point in accumulated sequence data with reference to the local space configuration scheme. An input to the point registration device 400 may be accumulated point cloud sequence data \hat{P}. Any point vector \hat{p}_{n,m} in data may include coordinate information of a corresponding point. The initialized point registration information I¹ may also be an input value to the point registration device 400. An output of the point registration device 400 may be point registration information I² in which local information is registered (or updated) for each point.

For reference, a local space index s may be, for example, information corresponding to a third dimension of the point registration information vector for the single point. Which local space each point is in (or a local space index) may be checked via coordinate information for each point in accumulated sequence data given as an input to update corresponding information.

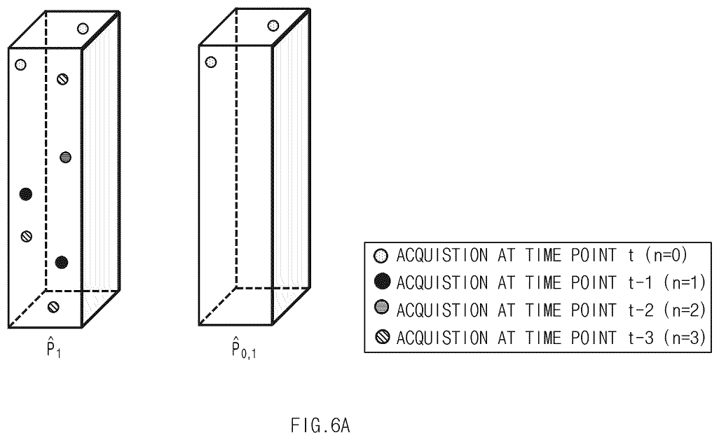

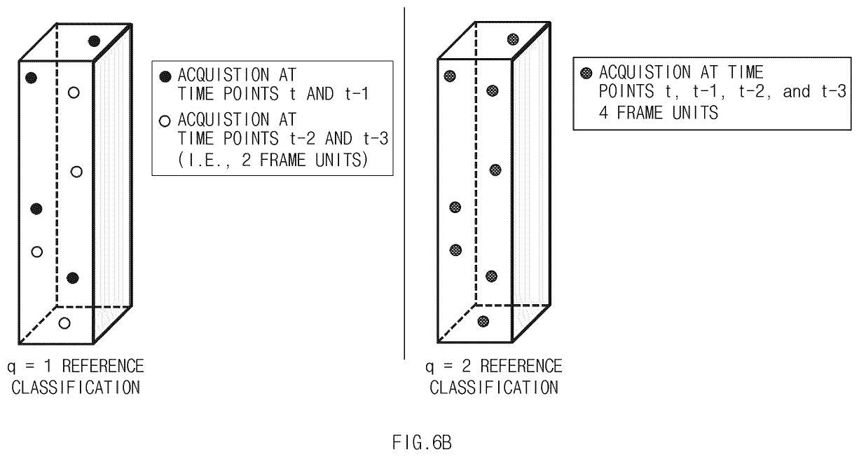

FIGS. 6A and 6B are drawings for describing an example process of searching for a point for a local space to perform augmentation and classifying the point for each local time type.

Describing FIGS. 6A and 6B, accumulated sequence data \hat{P} in the two drawings may be represented as input

$$\hat{P} = {\{ {\{ {\hat{p}}_{n , m} \}}_{m = 1}^{{M}_{t - n}} \}}_{n = 0}^{N - 1} .$$

Herein, this has a relationship, \hat{p}_{n,m}=[x_{n,m},y_{n,m},z_{n,m},r_{n,m},t̅_{n,m}]∈R⁵. For reference, \hat{p}_{n,m} is an initial feature vector for an m-th point of an (t−n)-th frame, which is feature vector including default information including position information and a timestamp and R⁵ refers to a five-dimensional vector space. The five dimensions of R⁵ may be the 3D coordinates (x,y,z), a LiDAR (or lidar) reflective index r, and a time offset t̅ relative to time t.

The accumulated sequence data \tilde{P} after augmenting a feature vector of a point cluster associated with a local spatiotemporal feature may be indicated as

$$\tilde{P} = {\{ {\{ {\tilde{p}}_{n , m} \}}_{m = 1}^{{M}_{t - n}} \}}_{n = 0}^{N - 1} .$$

A relationship \tilde{p}_{n,m}=[x_{n,m},y_{n,m},z_{n,m},r_{n,m},t̅_{n,m},x̅_{n,m,1},y̅_{n,m,1},z̅_{n,m,1},x̅_{n,m,2},y̅_{n,m,2},z̅_{n,m,2},x̅_{n,m,3},y̅_{n,m,3},z̅_{n,m,3}]∈R¹⁴, is established.

For reference, \tilde{p}_{n,m} is a feature vector in which spatiotemporal feature information about an m-th point of a (t−n)-th frame is augmented and R¹⁴ is a fourteen-dimensional vector space. The fourteen dimensions of R¹⁴ may be, for example, the 3D coordinates (x,y,z), the LiDAR (or lidar) reflective index r, the time offset t̅ relative to time point t, and 9 dimensions representing feature information augmented for, for example, local time units 2, 5, and 10 of the m-th point obtained at the (t−n)-th frame for each of the 3D coordinates.

\hat{P}_{n,s} which is a target of the augmentation in the accumulated sequence data \hat{P} may be a point set corresponding to a frame index among points constituting \hat{P}ₛ and \hat{P}_{n,s} ∈\hat{P}ₛ. \hat{P}ₛ may be a point set included in an s-th local space among the points constituting \hat{P} and \hat{P}ₛ ∈\hat{P}. Having a relationship of

$${\hat{P}}_{n s} ∈ {\hat{P}}_{n , s}^{q}$$

including \hat{P}_{n,s} as a point set included in the same local space-time as \hat{P}_{n,s} in \hat{P}ₛ may be defined as

$${\hat{P}}_{n s}^{q} .$$

Herein, a local space index s to which a point belongs may have a relationship of 1≤s≤S (however, S is the total number of local spaces for input data).

In other words, as shown in FIGS. 6A and 6B, for the present disclosure, it is characterized that the augmenting of the feature vector of the point cluster includes calculating arithmetic mean coordinates from a plurality of point coordinates and calculating a deviation between the points corresponding to s and n, respectively, in the accumulated sequence data.

In the present disclosure, the local spatiotemporal feature information calculation and augmentation may be executed in an index search order based on point spatiotemporal registration information I², which may be executed in an order of a local space index, a frame index, and a local time type index (refer to a local time type).

Point search in the same local space-time is a process of searching for points suitable for a condition with reference to the point spatiotemporal registration information I² and the local time configuration scheme.

A detailed operation of a local spatiotemporal feature computation and augmentation device 500 of FIG. 2 is summarized again based on the above as follows.

In other words, if the local space index s to perform augmentation is specified, a search start local space index is “1”. A point at which the space index value of the point registration information vector is s is searched for. \hat{P}ₛ Indicates a point set included in the s-th local space among points constituting \hat{P}. A frame index (or an acquisition time point) n to perform augmentation in the accumulated sequence data is specified. The search start frame index is set as “0” (e.g., a frame index corresponding to time point t). Thereafter, a point corresponding to a given frame index among the found points is searched for. A point set in which the frame index and the local space index of the point registration information vector correspond to n, s, respectively, is first derived. A point set corresponding to the frame index among the points constituting \hat{P}_{n,s}, that is, \hat{P}ₛ is obtained. \hat{P}_{n,s} corresponds to a target in which feature information will be augmented based on the local time configuration scheme used in the system.

For example, the process of searching for \hat{P}_{0,1} which satisfies (n,s)=(0,1) for the case in which N=4 is exemplified above in FIG. 5A.

Although described above in FIG. 3, the local spatiotemporal feature computation and augmentation device 500 may perform augmentation for all local time types, which may perform the augmentation with reference to the local time configuration scheme stored in a local time definition system, may perform the augmentation for each local time type (or a total of Q times), may derive a local time to suit given local time definition, and may search for a point in the same local space-time as \hat{P}_{n,s} based on the derived local time. At this time,

$${\hat{P}}_{n , s}^{q}$$

is a point set included in the same local space-time as \hat{P}_{n,s} in \hat{P}ₛ, which includes \hat{P}_{n,s}.

If the divisor-based equal division technique exemplified above is used, the local time type is 2 and 4 frames (if all divisors of the sequence length of 4 are used) and a point included in the same local space-time as points corresponding to (n,s)=(0,1) is searched for.

The configuration of the found point set

$${\hat{P}}_{n , s}^{q}$$

varies with the local time type q∈{1,2}. As shown in FIG. 6B,

$${\hat{P}}_{0 , 1}^{1}$$

is composed of 4 points and

$${\hat{P}}_{0 , 1}^{2}$$

is composed of 8 points.

Because the local spatiotemporal feature computation and augmentation device 500 performs augmentation for all local time types, a scheme for deriving spatiotemporal feature information from

$${\hat{P}}_{n , s}^{q}$$

the point set in the same local space-time (the result of searching for the local time type q) and deriving feature information between multiple points constituting

$${\hat{P}}_{n , s}^{q}$$

may be various applied.

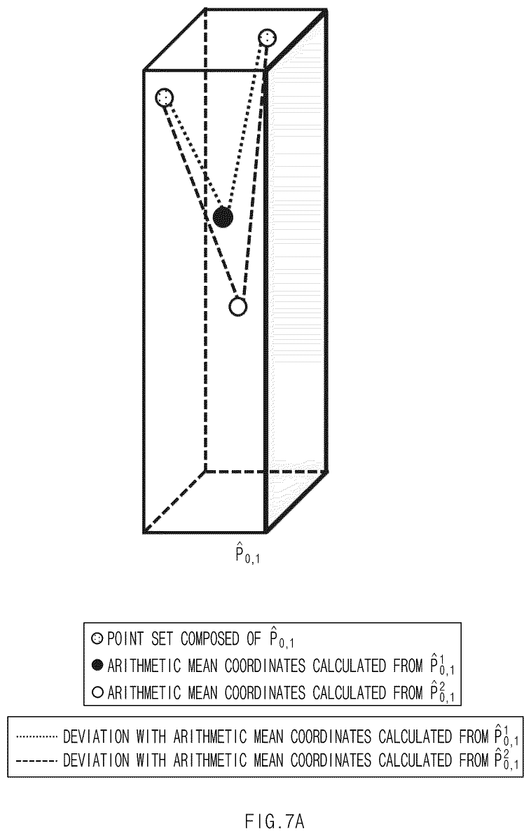

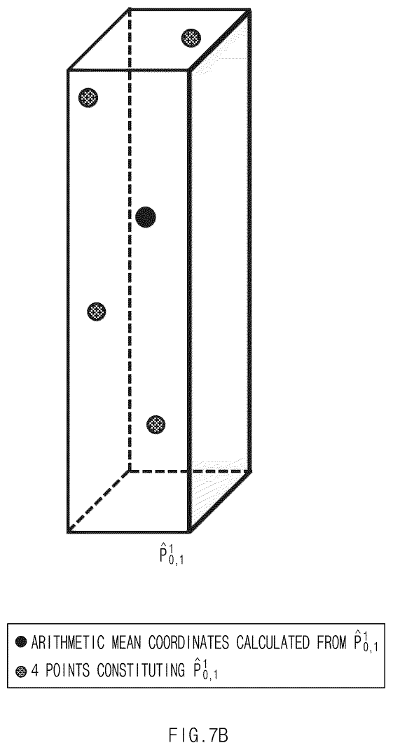

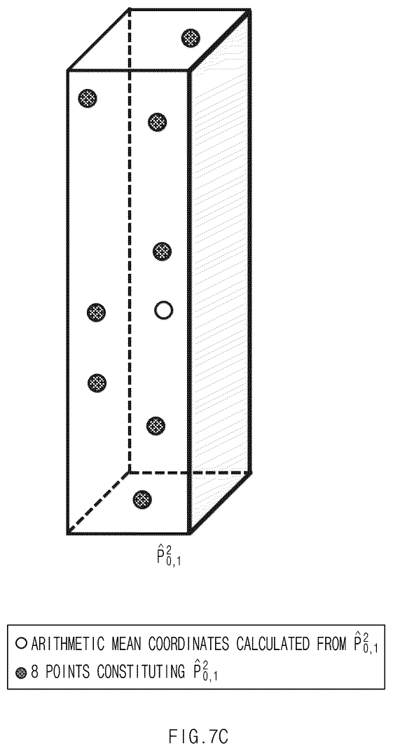

However, the present disclosure proposes a technique for deriving arithmetic mean-based relative position information and augmenting it. FIGS. 7A, 7B, and 7C are drawings for describing an example process of calculating and augmenting local spatiotemporal feature information.

Referring to FIGS. 7A to 7C, arithmetic mean coordinates are the result of calculating an arithmetic mean for position coordinates of points constituting

$${\hat{P}}_{n , s}^{q}$$

as shown in FIG. 7A. A dimension number representing the arithmetic mean coordinates is determined according to a dimension number for position information of point data used in the system. For example, if coordinates indicating a position of a point used in the system is 3D information, arithmetic mean coordinates also correspond to the 3D information.

Augmentation information may be deviation information between position coordinates of each point in \hat{P}_{n,s} and arithmetic mean coordinates. The augmentation information indicates relative position information the position of a point to be augmented has from the arithmetic mean coordinates. \hat{P}_{n,s} Is a point set having a space index s and a frame index n, which is a feature information augmentation target.

If divisor-based equal division is used, as shown in FIG. 7B,

$${\hat{P}}_{0 , 1}^{1}$$

-based arithmetic mean coordinates and augmentation information are calculated. Arithmetic mean coordinates are calculated from 4 point coordinates. A deviation between points constituting \hat{P}_{0,1} is calculated. If the

$${\hat{P}}_{0 , 1}^{2}$$

-based arithmetic mean coordinates and the augmentation information are calculated, as shown in FIG. 7C, arithmetic mean coordinates are calculated from 8 point coordinates and a deviation between points constituting \hat{P}_{0,1} is calculated.

Augmentation for all local time types used in an augmentation system should be performed. Augmentation information calculated for a single point vector constituting \hat{P}_{n,s} is added and the augmentation process is completed. The augmented point vector is in the form of a vector in which a dimension more emerges than before the augmentation. If the divisor-based equal division is applied, a point set corresponding to (n,s)=(0,1) is \hat{P}_{0,1}={\hat{p}_{0,m}_{₁},\hat{p}_{0,m}_{₂}}. Herein, m₁, m₂ is a point index in point cloud data obtained at frame index n=0, which is, \hat{p}_{0,m}=[x_{0,m}, y_{0,m}, z_{0,m}, . . . ]∈R^{l}, m∈{m₁, m₂}. In other words, it is assumed ([x,y,z]∈R³) that a point used in the entire system is a 3D point.

If

$${\hat{P}}_{0 , 1}^{1}$$

-based spatiotemporal feature information is augmented, arithmetic mean coordinates calculated from

$${\hat{P}}_{0 , 1}^{1}$$

are

$$[ {x}_{0 , 1}^{1} , {y}_{0 , 1}^{1} , {z}_{0 , 1}^{1} ] ∈ {R}^{3} and$$

$${\hat{p}}_{0 , m} = [ {x}_{0 , m} , {y}_{0 , m} , {z}_{0 , m} , … , ( {x}_{0 , m} - {x}_{0 , 1}^{1} ) , ( {y}_{0 , m} - {y}_{0 , 1}^{1} ) , ( {z}_{0 , m} - {z}_{0 , 1}^{1} ) ] ∈ {R}^{l + 3} ,$$

$$m ∈ \{ {m}_{1} , {m}_{2} \} .$$

### If

$${\hat{P}}_{0 , 1}^{2}$$

-based spatiotemporal feature information is augmented, arithmetic mean coordinates calculated from

$${\hat{P}}_{0 , 1}^{2}$$

are

$$[ {x}_{0 , 1}^{2} , {y}_{0 , 1}^{2} , {z}_{0 , 1}^{2} ] ∈ {R}^{3} and$$

$${\hat{p}}_{0 , m} = [ {x}_{0 , m} , {y}_{0 , m} , {z}_{0 , m} , … , ( {x}_{0 , m} - {x}_{0 , 1}^{1} ) , ( {y}_{0 , m} - {y}_{0 , 1}^{1} ) , ( {z}_{0 , m} - {z}_{0 , 1}^{1} ) , ( {x}_{0 , m} - {x}_{0 , 1}^{2} ) , ( {y}_{0 , m} - {y}_{0 , 1}^{2} ) , ( {z}_{0 , m} - {z}_{0 , 1}^{2} ) ] ∈ {R}^{l + 6} ,$$

$$m ∈ \{ {m}_{1} , {m}_{2} \} .$$

Augmentation is ended for all local time types (q∈{1,2}), \tilde{P}_{0,1} is derived. In other words, it corresponds to a subset of a final output \tilde{P} of the augmentation system (\tilde{P}_{0,1}∈\tilde{P}). It is a point set \tilde{P}_{0,1}={\tilde{p}_{0,m}_{₁},\tilde{p}_{0,m}_{₂}} corresponding to (n,s)=(0, 1) and

$${\hat{p}}_{0 , m} = [ {x}_{0 , m} , {y}_{0 , m} , {z}_{0 , m} , … , ( {x}_{0 , m} - {x}_{0 , 1}^{1} ) , ( {y}_{0 , m} - {y}_{0 , 1}^{1} ) , ( {z}_{0 , m} - {z}_{0 , 1}^{1} ) , ( {x}_{0 , m} - {x}_{0 , 1}^{2} ) , ( {y}_{0 , m} - {y}_{0 , 1}^{2} ) , ( {z}_{0 , m} - {z}_{0 , 1}^{2} ) ] ∈ {R}^{l + 6} ,$$

$$m ∈ \{ {m}_{1} , {m}_{2} \} .$$

A dimension number representing arithmetic mean coordinates in the present disclosure is determined according to a dimension number for position information of point data used in the system. For example, if coordinates indicating a position of a point used in the system is 3D information, arithmetic mean coordinates also correspond to the 3D information. Augmentation information may be deviation information between position coordinates of each point in \hat{P}_{n,s} and arithmetic mean coordinates. This indicates relative position information the position of the point to be augmented has from the arithmetic mean coordinates.

FIG. 8 is a block diagram illustrating an example computing system 1000 for autonomous vehicle control and object detection computation.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read-only memory (ROM) 1310 and a random access memory (RAM) 1320.

Accordingly, the operations of the method or algorithm described herein may be directly implemented with a hardware module, a software module, or a combination of the hardware module and the software module, which may be executed by the processor 1100. The software module may reside on a storage medium (e.g., the memory 1300 and/or the storage 1600) such as a RAM, a flash memory, a ROM, an EPROM, an EEPROM, a register, a hard disc, a removable disk, and a CD-ROM.

The storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

In the present disclosure, a deep learning technology based on point cloud data for autonomous driving relates to a technology for using point cloud data obtained from an autonomous driving sensor, such as LIDAR or RADAR, as an input to a deep learning network to recognize an environment around an autonomous vehicle.

Herein a recognition, perception, or detection technology detects a moving/static object and includes a technology, such as semantic segmentation (e.g., segmentation, class classification, and the like) or object tracking.

Particularly, the present disclosure is a technology for accumulating an image frame obtained from the autonomous driving sensor, such as a plurality of LiDAR, based on subsequent point cloud data (hereinafter, referred to as a “point cloud sequence”). In other words, the present disclosure is a technology for merging pieces of point cloud data obtained at a certain period from a sensor on the basis of a specific time point, which accumulates data (hereinafter, referred to as a “target frame”) obtained at a past time point with respect to a time point when the recognition technology is performed (hereinafter, referred to as a “past frame”).

The accumulation scheme of the present disclosure is a scheme which calculates motion information of an ego-vehicle from the past frame acquisition time point to the target frame acquisition time point and compensates and merges it.

The advantage of the point cloud sequence accumulation technology used in the present disclosure is to provide more pieces of surrounding information for the recognition technology to be performed. Particularly, the reflected and obtained point density may become lower as the distance is longer from the sensor. The limitation of point cloud data, only a portion of which is obtained due to an overlap between elements (e.g., objects) in a surrounding environment, may be improved.

At least in some implementations, spatiotemporal feature information may not be used in using accumulated point cloud data as a recognition system input. For example, a point cloud sequence may be accumulated to improve sensor data scarcity. For example, at least in some implementations, spatiotemporal information, which is present in accumulated data, may not be sufficiently utilized if increasing density of point data to recognize an object around an autonomous vehicle.

In addition, the objective of the present disclosure is to define a local spatiotemporal domain for point cloud data accumulated on the time axis, derive feature information between points which are present in the same domain, and perform augmentation of point feature information based on it. The “augmentation” in the present disclosure refers to an increase in the amount of information representing a single point.

For example, while the form of information about a single point is a point vector [x,y,z]∈R³ indicating position information in some implementations for handling 3D point cloud data, the present disclosure adds the feature information newly derived in the defined local space-time to the point vector information to increase the amount of information of the point vector (R³→R⁽³⁺ⁿ⁾). In other words, because the amount of point feature information available in an AI object detection system increases, it may be expected to improve recognition performance.

Object detection system performance via local spatiotemporal feature information augmentation according to the present disclosure does not just accumulate a point cloud sequence to improve sensor data scarcity as in some other implementations, which is to define a local space-time in sequence data, derive additional feature information from a point set which is present in a corresponding area, and use it. The “augmentation” according to the present disclosure contributes to amplifying the amount of information of an initial feature vector for each point used in a point cloud-based recognition technology to increase object detection performance. For reference, the “augmentation” may correspond to pre-processing in light of the overall process of the object detection system.

In addition, the present disclosure may configure a system to perform spatiotemporal domain registration and feature information calculation form multiple points in sequence data using a GPU, an NPU, or the like for supporting parallel computation. The present disclosure may register local spatiotemporal domain definition and point for accumulated point cloud sequence data and may define and configure a local spatiotemporal domain with regard to a space region of interest (or a sensor data input space) and a sequence data length (e.g., a frame) of the detection system. In detail, the present disclosure may present an “equal division scheme based on a divisor of a sequence length” for configuring the defined local time. Furthermore, the present disclosure may use a “voxelization” scheme for configuring the defined local space.

If registering the above-mentioned point information, the present disclosure proposes a data structure (e.g., “spatiotemporal point registration information” presented in the present disclosure) for dividing a spatiotemporal domain including any point in sensor data and proposes a structure for searching for points in an interesting local spatiotemporal domain using it. This is a feature information calculation and augmentation technology for a point set in the local spatiotemporal domain. A scheme for calculating feature information from a point set registered in the same local spatiotemporal domain may vary. The present disclosure presents a scheme for calculating geometric feature information (particularly, deviation information with arithmetic mean coordinates).

Thus, the present disclosure is able to augment point feature vector information based on the calculated feature information, add feature information in the spatiotemporal domain in information representing a single point, and be expanded and applied to all detection systems which use point cloud sequence data obtained from an autonomous driving sensor.

Although a position information form for each point according to output specifications of the autonomous driving sensor differs, because a division technology in units of a local time and a local space, which is applied in the present disclosure, is applicable regardless of the form, the present disclosure is evaluated to have expandability in application.

In addition, those skilled in the air may understand various effects other than the effects described above from the present disclosure, via the detailed description of the present disclosure and the accompanying drawings.

According to an aspect of the present disclosure, a system for recognizing an object based on an artificial intelligence (AI) module and a three-dimensional (3D) autonomous driving sensor may include a processor that controls a computation and augmentation device for executing a local spatiotemporal feature information computation and augmentation operation for an object in a surrounding environment, the object being recognized from a plurality of pieces of point data input from the 3D autonomous driving sensor, and loaded with the AI module and a memory storing the plurality of pieces of input point data as accumulated sequence data including a plurality of frames accumulated in units of time and a frame. The AI module may interwork with the computation and augmentation device to execute specifying a local space index to perform the augmentation operation based on a certain local space configuration scheme and initializing and registering point spatiotemporal registration information of the accumulated sequence data based on the local space index s, searching for a point corresponding to the specified local space index, specifying a frame index n to perform the augmentation operation among a plurality of pieces of sequence data input from the 3D autonomous driving sensor and including a frame accumulated for each time, based on a local time type q (which is present from q₁ to q_{Q}) according to the certain local time configuration scheme, searching for a point corresponding to the specified frame index and setting a point index m, defining a local space-time based on the specified local space index at the specified frame index and searching for a point corresponding to the specified local space index at the specified frame index to calculate a local spatiotemporal feature of the point, and augmenting a feature vector of a point cluster associated with the local spatiotemporal feature based on the calculated local spatiotemporal feature.

In the system according to another aspect of the present disclosure, the local time configuration scheme may be a divisor-based equal division scheme.

In the system according to another aspect of the present disclosure, the local space configuration scheme may be a voxelization-based local space configuration scheme or an exclusive clustering-based local space configuration scheme.

In the system according to another aspect of the present disclosure, the point spatiotemporal registration information I before being initialized may be calculated as in Equation 1 below.

$$I = {\{ {\{ {I}_{n , m} \}}_{m = 1}^{{M}_{t - n}} \}}_{n = 0}^{N - 1} \qquad < Equation 1 >$$

Here, (i) the subscript n is a frame index n indicating an acquisition time point of a corresponding point in an accumulated sequence, and 0≤n≤N−1, (ii) N is the total number of frames included in the accumulated sequence, and (iii) the subscript m is an index indicating one of a plurality of points in a frame corresponding to n and 1≤m≤Mₜ₋ₙ (however, Mₜ₋ₙ is the total number of points of point cloud data obtained at time point (t−n)).

In the system according to another aspect of the present disclosure, the initialized point spatiotemporal registration information I¹ may be calculated as in Equation 1-1 below.

$${I}^{1} = {\{ {\{ {I}_{n , m}^{1} \}}_{m = 1}^{{M}_{t - n}} \}}_{n = 0}^{N - 1} , {I}_{n , m}^{1} = [ n , m , - 1 ] ∈ {R}^{3} \qquad < Equation 1 - 1 >$$

Here, R³ denotes a 3D vector space.

In the system according to another aspect of the present disclosure, the point spatiotemporal registration information I² registered based on the local space index s may be calculated as in Equation 1-2 below,

$${I}^{2} = {\{ {\{ {I}_{n , m}^{2} \}}_{m = 1}^{{M}_{t - n}} \}}_{n = 0}^{N - 1} {I}_{n , m}^{2} ∈ {R}^{3} \qquad < Equation 1 - 2 >$$

In the system according to another aspect of the present disclosure, the accumulated sequence data \hat{P} may be represented as in Equations 2 and 2-1 below,

$$\hat{P} = {\{ {\{ {\hat{p}}_{n , m} \}}_{m = 1}^{{M}_{t - n}} \}}_{n = 0}^{N - 1} \qquad < Equation 2 >$$

$${\hat{p}}_{n , m} = [ {x}_{n , m} , {y}_{n , m} , {z}_{n , m} , {r}_{n , m} , {\overline{t}}_{n , m} ] ∈ {R}^{5} \qquad < Equation 2 - 1 >$$

Here, (i) the subscript n is a frame index n indicating an acquisition time point of a corresponding point in an accumulated sequence and 0≤n≤N−1, (ii) N is the total number of frames included in the accumulated sequence, (iii) the subscript m is an index indicating one of a plurality of points in a frame corresponding to n and 1≤m≤Mₜ₋ₙ (however, Mₜ₋ₙ is the total number of points of point cloud data obtained at time point (t−n)), (iv) Pnm is an initial feature vector for an mth point of a (t−n)th frame and is a feature vector including default information including position information and a timestamp, and (v) R⁵ refers to a time offset t̅ with respect to 3D (x,y,z) coordinates, a LiDAR reflective index r, and time point t).

In the system according to another aspect of the present disclosure, the accumulated sequence data \tilde{P} after augmenting the feature vector of the point cluster associated with the local spatiotemporal feature may be represented as in Equations 3 and 3-1 below.

$$\tilde{P} = {\{ {\{ {\tilde{P}}_{n , m} \}}_{m = 1}^{{M}_{t - n}} \}}_{n = 0}^{N - 1} \qquad < Equation 3 >$$

$${\tilde{p}}_{n , m} = [ {x}_{n , m} , {y}_{n , m} , {z}_{n , m} , {r}_{n , m} , {\overline{t}}_{n , m} , {\overline{x}}_{n , m , 1} , {\overline{y}}_{n , m , 1} , {\overline{z}}_{n , m , 1} , {\overline{x}}_{n , m , 2} , {\overline{y}}_{n , m , 2} , {\overline{z}}_{n , m , 2} , {\overline{x}}_{n , m , 3} , {\overline{y}}_{n , m , 3} , {\overline{z}}_{n , m , 3} ] ∈ {R}^{14} \qquad < Equation 3 - 1 >$$

Here, (i) the subscript n is a frame index n indicating an acquisition time point of a corresponding point in an accumulated sequence and 0≤n≤N−1, (ii) N is the total number of frames included in the accumulated sequence, (iii) the subscript m is an index indicating one of a plurality of points in a frame corresponding to n and 1≤m≤Mₜ₋ₙ (however, Mₜ₋ₙ is the total number of points of point cloud data obtained at time point (t−n)), (iv) \tilde{P}_{n,m} is a feature vector in which spatiotemporal feature information is augmented for an mth point of a (t−n)th frame, and (v) R¹⁴ is a time offset t with respect to 3D (x,y,z) coordinates, a LiDAR reflective index r, and time point t and is composed of a total of 14 items including a total of 9 items of feature information augmented for local time units 2, 5, and 10 of an mth point obtained at a (t−n)th frame for each of 3D coordinates.

In the system according to another aspect of the present disclosure, \hat{P}_{n,s} which is a target of the augmentation in the accumulated sequence data \hat{P} may be a point set corresponding to a frame index among points constituting \hat{P}ₛ and \hat{P}_{n,s} ∈\hat{P}ₛ. \hat{P}ₛ may be a point set included in an sth local space among the points constituting \hat{P} and \hat{P}ₛ ∈\hat{P}. Having a relationship of \hat{P}_{n,s} ∈

$${\hat{P}}_{n , s}^{q}$$

including \hat{P}_{n,s} as a point set included in the same local space-time as \hat{P}_{n,s} in \hat{P}ₛ may be defined as

$${\hat{P}}_{n , s}^{q} .$$

A local space index s to which a point belongs may have a relationship of 1≤s≤S (however, S is the total number of local spaces for input data).

In the system according to another aspect of the present disclosure, the augmenting of the feature vector of the point cluster may include calculating arithmetic mean coordinates from a plurality of point coordinates and calculating a deviation between the points corresponding to s and n in the accumulated sequence data.

According to another aspect of the present disclosure, a method for executing a local spatiotemporal feature information computation and augmentation operation for an object of a surrounding environment recognized from a plurality of point data input from an AI module and a 3D autonomous driving sensor and recognizing the object may be presented. In other words, the AI module may include storing the plurality of pieces of input point data as accumulated sequence data including a plurality of frames accumulated on a frame-by-frame basis from the 3D autonomous driving sensor, specifying a local space index to perform the augmentation operation based on a certain local space configuration scheme and initializing and registering point spatiotemporal registration information of the accumulated sequence data based on the local space index s, searching for a point corresponding to the specified local space index, specifying a frame index n to perform the augmentation operation among a plurality of pieces of sequence data input from the 3D autonomous driving sensor and including a frame accumulated for each time, based on a local time type q (which is present from q₁ to q_{Q}) according to the certain local time configuration scheme, searching for a point corresponding to the specified frame index and setting a point index m, defining a local space-time based on the specified local space index at the specified frame index and searching for a point corresponding to the specified local space index at the specified frame index to calculate a local spatiotemporal feature of the point, and augmenting a feature vector of a point cluster associated with the local spatiotemporal feature based on the calculated local spatiotemporal feature.

Hereinabove, although the present disclosure has been described with reference to example embodiment(s) and the accompanying drawings, the present disclosure is not limited thereto, but may be variously modified and altered by those skilled in the art to which the present disclosure pertains without departing from the spirit and scope of the present disclosure claimed in the following claims.

Therefore, example embodiment(s) of the present disclosure may not be intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus of a vehicle, the apparatus comprising:
a three-dimensional (3D) sensor configured to obtain a plurality of point data associated with a surrounding environment of the vehicle;
a memory configured to store the plurality of point data, obtained by the 3D sensor, as accumulated sequence data, wherein the accumulated sequence data comprises a plurality of frames sequentially arranged in time; and
a processor configured to:
specify, based on a predetermined local space configuration scheme, a local space index for performing an augmentation operation associated with an object, in the surrounding environment, that is recognized, based on the plurality of point data;
initialize point spatiotemporal registration information of the accumulated sequence data;
register, based on the local space index, the initialized point spatiotemporal registration information;
search for a point corresponding to the specified local space index;
specify, among the plurality of frames of the accumulated sequence data and based on a local time type corresponding to a predetermined local time configuration scheme, a frame index for performing the augmentation operation;
determine a point index by searching for a point corresponding to the specified frame index;
define, at the specified frame index and based on the specified local space index, a local space-time;
search for a point corresponding to the specified local space index at the specified frame index to determine a local spatiotemporal feature of the point;
augment, based on the determined local spatiotemporal feature, a feature vector of a point cluster associated with the local spatiotemporal feature;
detect, based on the feature vector of the point cluster, the object in the surrounding environment of the vehicle; and
control, based on the detected object, an autonomous driving operation of the vehicle.

2. The apparatus of claim 1, wherein the predetermined local time configuration scheme is a divisor-based equal division scheme.

3. The apparatus of claim 1, wherein the predetermined local space configuration scheme is at least one of: a voxelization-based local space configuration scheme or an exclusive clustering-based local space configuration scheme.

4. The apparatus of claim 1, wherein the processor is further configured to:
determine, before the point spatiotemporal registration information is initialized, the point spatiotemporal registration information according to an equation,
$$I = {\{ {\{ {I}_{n , m} \}}_{m = 1}^{{M}_{t - n}} \}}_{n = 0}^{N - 1} ,$$
wherein I denotes the point spatiotemporal registration information before initialization, wherein n denotes a frame index indicating an acquisition time of a corresponding point in the accumulated sequence data, wherein N denotes a quantity of the plurality of frames included in the accumulated sequence data, wherein 0≤n≤N−1, wherein m denotes an index indicating one of a plurality of points in a frame corresponding to n, wherein t denotes a current time, wherein Mₜ₋ₙ denotes a total quantity of points in point cloud data obtained at time t−n, and wherein 1≤m≤Mₜ₋ₙ.

5. The apparatus of claim 4, wherein the processor is configured to initialize the point spatiotemporal registration information by:
determining the initialized point spatiotemporal registration information according to an equation,
$${I}^{1} = {\{ {\{ {I}_{n , m}^{1} \}}_{m = 1}^{{M}_{t - n}} \}}_{n = 0}^{N - 1} , {I}_{n , m}^{1} = [ n , m , - 1 ] ∈ {R}^{3} ,$$
wherein I¹ denotes the initialized point spatiotemporal registration information, and wherein R³ denotes a 3D vector space.

6. The apparatus of claim 1, wherein the processor is configured to register the initialized point spatiotemporal registration information by:
determining the registered point spatiotemporal registration information according to an equation,
$${I}^{2} = {\{ {\{ {I}_{n , m}^{2} \}}_{m = 1}^{{M}_{t - n}} \}}_{n = 0}^{N - 1} {I}_{n , m}^{2} ∈ {R}^{3} ,$$
wherein I² denotes the registered point spatiotemporal registration information, wherein n denotes a frame index indicating an acquisition time of a corresponding point in the accumulated sequence data, wherein N denotes a quantity of the plurality of frames included in the accumulated sequence data, wherein 0≤n≤N−1, wherein m denotes an index indicating one of a plurality of points in a frame corresponding to n, wherein t denotes a current time, wherein Mₜ₋ₙ denotes a total quantity of points in point cloud data obtained at a time t−n, wherein 1≤m≤Mₜ₋ₙ, and wherein R³ denotes a 3D vector space.

7. The apparatus of claim 1, wherein the accumulated sequence data is represented by equations,
$$\hat{P} = {\{ {\{ {\hat{p}}_{n , m} \}}_{m = 1}^{{M}_{t - n}} \}}_{n = 0}^{N - 1} , and$$
$${\hat{p}}_{n , m} = [ {x}_{n , m} , {y}_{n , m} , {z}_{n , m} , {r}_{n , m} , {\overline{t}}_{n , m} ] ∈ {R}^{5} ,$$
wherein \hat{P} denotes the accumulated sequence data, wherein n denotes a frame index indicating an acquisition time of a corresponding point in the accumulated sequence data, wherein N denotes a quantity of the plurality of frames included in the accumulated sequence data, wherein 0≤n≤N−1, wherein m denotes an index indicating one of a plurality of points in a frame corresponding to n, wherein t denotes a current time, wherein Mₜ₋ₙ denotes a total quantity of points in point cloud data obtained at time t−n, wherein 1≤m≤Mₜ₋ₙ, wherein \hat{p}_{n,m} denotes an initial feature vector for an m-th point in a (t−n)-th frame of the plurality of frames, wherein the initial feature vector comprises position information and a timestamp, and wherein R⁵ denotes a five-dimension vector space having 3D coordinates (x, y, z), a lidar reflective index r, and a time offset t̅, relative to time t, as dimensions of the five-dimension vector space.

8. The apparatus of claim 1, wherein the accumulated sequence data after the feature vector of the point cluster associated with the local spatiotemporal feature is augmented is represented by equations,
$$\tilde{P} = {\{ {\{ {\tilde{P}}_{n , m} \}}_{m = 1}^{{M}_{t - n}} \}}_{n = 0}^{N - 1} , and$$
$${\tilde{p}}_{n , m} = [ \begin{matrix}{x}_{n , m} , {y}_{n , m} , {z}_{n , m} , {r}_{n , m} , {\overline{t}}_{n , m} , {\overline{x}}_{n , m , 1} , {\overline{y}}_{n , m , 1} , {\overline{z}}_{n , m , 1} , \\ {\overline{x}}_{n , m , 2} , {\overline{y}}_{n , m , 2} , {\overline{z}}_{n , m , 2} , {\overline{x}}_{n , m , 3} , {\overline{y}}_{n , m , 3} , {\overline{z}}_{n , m , 3}\end{matrix} ] ∈ {R}^{14} ,$$
wherein \tilde{P} denotes the accumulated sequence data after the feature vector of the point cluster associated with the local spatiotemporal feature is augmented, wherein n denotes a frame index indicating an acquisition time of a corresponding point in the accumulated sequence data, wherein N denotes a quantity of the plurality of frames included in the accumulated sequence data, wherein 0≤n≤N−1, wherein m denotes an index indicating one of a plurality of points in a frame corresponding to n, wherein t denotes a current time, wherein Mₜ₋ₙ denotes a total quantity of points in point cloud data obtained at time t−n, wherein 1≤m≤Mₜ₋ₙ, wherein \tilde{p}_{n,m} denotes an augmented feature vector in which spatiotemporal feature information is augmented for an m-th point in a (t−n)-th frame, wherein R¹⁴ denotes a fourteen-dimension vector space, and wherein dimensions of the fourteen-dimension vector space comprise 3D coordinates (x,y,z), a lidar reflective index r, a time offset t̅, relative to time t, and feature information augmented at a first local time unit, a second local time unit, and a third local time unit in an m-th point obtained in a (t−n)-th frame for each of 3D coordinates.

9. The apparatus of claim 7, wherein \hat{P}_{n,s} is a target of augmentation in the accumulated sequence data \hat{P}, wherein s is the local space index, wherein \hat{P}_{n,s} is a point set corresponding to a frame index among points constituting \hat{P}ₛ and \hat{P}_{n,s} ∈\hat{P}ₛ,
wherein \hat{P}ₛ is a point set included in an s-th local space among points constituting \hat{P} and \hat{P}ₛ ∈\hat{P},
wherein having a relationship of
$${\hat{P}}_{n , s} ∈ {\hat{P}}_{n , s}^{q}$$
including \hat{P}_{n,s} as a point set included in a same local space-time as \hat{P}_{n,s} in \hat{P}ₛ is defined as
$${\hat{P}}_{n , s}^{q} ,$$
and
wherein the local space index s to which a point belongs has a relationship of 1≤s≤S, and wherein S is a total quantity of local spaces for input data.

10. The apparatus of claim 1, wherein the processor is configured to augment the feature vector of the point cluster by:
determining, based on a plurality of point coordinates of the point cluster, arithmetic mean coordinates of the point cluster; and
determining a deviation between points corresponding to the local space index and the frame index, respectively.

11. A method performed by an apparatus of a vehicle, the method comprising:
obtaining, via a three-dimensional (3D) sensor of the vehicle, a plurality of point data associated with a surrounding environment of the vehicle;
storing the plurality of point data as accumulated sequence data, wherein the accumulated sequence data comprises a plurality of frames sequentially arranged in time;
specifying, based on a predetermined local space configuration scheme, a local space index for performing an augmentation operation associated with an object, in the surrounding environment, that is recognized, based on the plurality of point data;
initializing point spatiotemporal registration information of the accumulated sequence data;
registering, based on the local space index, the initialized point spatiotemporal registration information;
searching for a point corresponding to the specified local space index;
specifying, among the plurality of frames of the accumulated sequence data and based on a local time type corresponding to a predetermined local time configuration scheme, a frame index for performing the augmentation operation;
determining a point index by searching for a point corresponding to the specified frame index;
defining, at the specified frame index and based on the specified local space index, a local space-time;
searching for a point corresponding to the specified local space index at the specified frame index to determine a local spatiotemporal feature of the point;
augmenting, based on the determined local spatiotemporal feature, a feature vector of a point cluster associated with the local spatiotemporal feature;
detecting, based on the feature vector of the point cluster, the object in the surrounding environment of the vehicle; and
controlling, based on the detected object, an autonomous driving operation of the vehicle.

12. The method of claim 11, wherein the predetermined local time configuration scheme is a divisor-based equal division scheme.

13. The method of claim 11, wherein the predetermined local space configuration scheme is at least one of: a voxelization-based local space configuration scheme or an exclusive clustering-based local space configuration scheme.

14. The method of claim 11, further comprising:
determining, before the initializing of the point spatiotemporal registration information, the point spatiotemporal registration information according to an equation,
$$I = {\{ {\{ {I}_{n , m} \}}_{m = 1}^{{M}_{t - n}} \}}_{n = 0}^{N - 1} ,$$
wherein, I denotes the point spatiotemporal registration information before initialization, wherein n denotes a frame index indicating an acquisition time of a corresponding point in the accumulated sequence data, wherein N denotes a quantity of the plurality of frames included in the accumulated sequence data, wherein 0≤n≤N−1, wherein m denotes an index indicating one of a plurality of points in a frame corresponding to n, wherein t denotes a current time, wherein Mₜ₋ₙ denotes a total quantity of points in point cloud data obtained at time t−n, and wherein 1≤m≤Mₜ₋ₙ.

15. The method of claim 14, wherein the initializing of the point spatiotemporal registration information comprises:
determining the initialized point spatiotemporal registration information,
$${I}^{1} = {\{ {\{ {I}_{n , m}^{1} \}}_{m = 1}^{{M}_{t - n}} \}}_{n = 0}^{N - 1} , {I}_{n , m}^{1} = [ n , m , - 1 ] ∈ {R}^{3} ,$$
wherein I¹ denotes the initialized point spatiotemporal registration information, and wherein R³ denotes a 3D vector space.

16. The method of claim 11, wherein the registering of the initialized point spatiotemporal registration information comprises:
determining the registered point spatiotemporal registration information according to an equation,
$${I}^{2} = {\{ {\{ {I}_{n , m}^{2} \}}_{m = 1}^{{M}_{t - n}} \}}_{n = 0}^{N - 1} {I}_{n , m}^{2} ∈ {R}^{3} ,$$
wherein I² denotes the registered point spatiotemporal registration information, wherein n denotes a frame index indicating an acquisition time of a corresponding point in the accumulated sequence data, wherein N denotes a quantity of the plurality of frames included in the accumulated sequence data, wherein 0≤n≤N−1, wherein m denotes an index indicating one of a plurality of points in a frame corresponding to n, wherein t denotes a current time, wherein Mₜ₋ₙ denotes a total quantity of points in point cloud data obtained at a time t−n, wherein 1≤m≤Mₜ₋ₙ, and wherein R³ denotes a 3D vector space.

17. The method of claim 11, wherein the accumulated sequence data is represented by equations,
$$\hat{P} = {\{ {\{ {\hat{p}}_{n , m} \}}_{m = 1}^{{M}_{t - n}} \}}_{n = 0}^{N - 1} , and$$
$${\hat{p}}_{n , m} = [ {x}_{n , m} , {y}_{n , m} , {z}_{n , m} , {r}_{n , m} , {\overline{t}}_{n , m} ] ∈ {R}^{5} ,$$
wherein \hat{P} denotes the accumulated sequence data, wherein n denotes a frame index indicating an acquisition time of a corresponding point in the accumulated sequence data, wherein N denotes a quantity of the plurality of frames included in the accumulated sequence data, wherein 0≤n≤N−1, wherein m denotes an index indicating one of a plurality of points in a frame corresponding to n, t denotes a current time, Mₜ₋ₙ denotes a total quantity of points in point cloud data obtained at time t−n, wherein 1≤m≤Mₜ₋ₙ, wherein pnm denotes an initial feature vector for an m-th point in a (t−n)-th frame of the plurality of frames, wherein the initial feature vector comprises position information and a timestamp, and wherein R⁵ denotes a five-dimension vector space having 3D coordinates (x,y,z), a lidar reflective index r, and a time offset t̅, relative to time t, as dimensions of the five-dimension vector space.

18. The method of claim 11, wherein the accumulated sequence data after the feature vector of the point cluster associated with the local spatiotemporal feature is augmented is represented by equations,
$$\tilde{P} = {\{ {\{ {\tilde{P}}_{n , m} \}}_{m = 1}^{{M}_{t - n}} \}}_{n = 0}^{N - 1} , and$$
$${\tilde{p}}_{n , m} = [ \begin{matrix}{x}_{n , m} , {y}_{n , m} , {z}_{n , m} , {r}_{n , m} , {\overline{t}}_{n , m} , {\overline{x}}_{n , m , 1} , {\overline{y}}_{n , m , 1} , {\overline{z}}_{n , m , 1} , \\ {\overline{x}}_{n , m , 2} , {\overline{y}}_{n , m , 2} , {\overline{z}}_{n , m , 2} , {\overline{x}}_{n , m , 3} , {\overline{y}}_{n , m , 3} , {\overline{z}}_{n , m , 3}\end{matrix} ] ∈ {R}^{14} ,$$
wherein \tilde{P} denotes the accumulated sequence data after the feature vector of the point cluster associated with the local spatiotemporal feature is augmented, n denotes a frame index indicating an acquisition time of a corresponding point in the accumulated sequence data, wherein N denotes a quantity of the plurality of frames included in the accumulated sequence data, wherein 0≤n≤N−1, wherein m denotes an index indicating one of a plurality of points in a frame corresponding to n, t denotes a current time, Mₜ₋ₙ denotes a total quantity of points in point cloud data obtained at time t−n, wherein 1≤m≤Mₜ₋ₙ, wherein Pnm denotes an augmented feature vector in which spatiotemporal feature information is augmented for an m-th point in a (t−n)-th frame, wherein R¹⁴ denotes a fourteen-dimension vector space, and wherein dimensions of the fourteen-dimension vector space comprise 3D coordinates (x,y,z), a lidar reflective index r, a time offset t̅, relative to time t, and feature information augmented at a first local time unit, a second local time unit, and a third local time unit in an m-th point obtained in a (t−n)-th frame for each of 3D coordinates.

19. The method of claim 17, wherein \hat{P}_{n,s} is a target of augmentation in the accumulated sequence data \hat{P}, wherein s is the local space index, wherein \hat{P}_{n,s} is a point set corresponding to a frame index among points constituting \hat{P}ₛ and \hat{P}_{n,s} ∈\hat{P}ₛ,
wherein \hat{P}ₛ is a point set included in an s-th local space among points constituting \hat{P}ₛ and \hat{P}ₛ ∈\hat{P},
wherein having a relationship of
$${\hat{P}}_{n , s} ∈ {\hat{P}}_{n , s}^{q}$$
including \hat{P}_{n,s} as a point set included in a same local space-time as \hat{P}_{n,s} in \hat{P}ₛ is defined as
$${\hat{P}}_{n , s}^{q} ,$$
and
wherein the local space index s to which a point belongs has a relationship of 1≤s≤S, and wherein S is a total quantity of local spaces for input data.

20. The method of claim 11, wherein the augmenting of the feature vector of the point cluster comprises:
determining, based on a plurality of point coordinates of the point cluster, arithmetic mean coordinates of the point cluster; and
determining a deviation between points corresponding to the local space index and the frame index, respectively.
